(19) United States
(12) Patent Application Publication
(10) Pub. No.: US 2024/0397434 A1
(43) Pub. Date: Nov. 28, 2024

(54) METHOD AND DEVICE IN NODES USED FOR WIRELESS COMMUNICATION

(71) Applicants: Qi JIANG, Shanghai (CN); Xiaobo ZHANG, Shanghai (CN)

(72) Inventors: Qi JIANG, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/793,950

(22) Filed: Aug. 5, 2024

Related U.S. Application Data
(63) Continuation of application No. PCT/CN2023/073534, filed on Jan. 28, 2023.

(30) Foreign Application Priority Data
Feb. 7, 2022 (CN) 202210115650.5

(51) Int. Cl. H04W 52/14; H04W 52/24; H04W 52/32

(52) U.S. Cl. CPC H04W 52/146; H04W 52/242; H04W 52/325

(57) ABSTRACT

The node firstly receives a first information set, the first information set indicating a first reference signal resource set and a second reference signal resource set; and then transmits a target signal, the target signal comprising a second information set; the second information set comprises a first power difference, or comprises a second power difference and a third power difference; the first power difference is associated with the first reference signal resource set or the second reference signal resource set; the second power difference and the third power difference are respectively associated with the first reference signal resource set and the second reference signal resource set; the target signal is used to determine whether the second information set comprises the first power difference or comprises both the second power difference and the third power difference. This application improves uplink power control for multi-panel terminals to increase system flexibility.

### CROSS REFERENCE TO RELATED APPLICATIONS

This application is the continuation of the international patent application No. PCT/CN2023/073534, filed on Jan. 28, 2023, and claims the priority benefit of Chinese Patent Application No. 202210115650.5, filed on Feb. 7, 2022, the full disclosure of which is incorporated herein by reference.

### BACKGROUND

### Technical Field

The present application relates to transmission methods and devices in wireless communication systems, and in particular to a transmission scheme and device for uplink power control reporting in wireless communications.

### Related Art

The 5G wireless cellular communication network system (5G-RAN) enhances the uplink power control of User Equipment (UE) based on the already-existing Long-Term Evolution (LTE). Compared to LTE, due to the absence of Common Reference Signal (CRS) in the 5G NR system, the measurement of pathloss required for uplink power control shall be performed using Channel State Information Reference Signal (CSI-RS) and SS/PBCH Block (SSB). In addition, the most important feature of the NR system is the introduction of the beam management mechanism. The terminal can communicate with multiple different transmitting and receiving beams, and thus the terminal needs to be able to measure multiple pathlosses corresponding to multiple beams, in which one way of determining the pathloss is to indicate to a certain associated downlink RS resource by means of a Sounding Reference Signal Resource Indicator (SRI) in the DCI.

In the discussion of NR R17, the scenario where multiple Panels are configured on the terminal side has been adopted, and the impact on power control brought about by the introduction of multiple Panels needs to be considered accordingly.

### SUMMARY

In the discussion of NR R17, enhancements are made to the terminal's transmissions, and one important aspect is the introduction of two Panels, which can be employed by the terminal to transmit on two transmitting beams at the same time in order to obtain better spatial diversity gain. However, one of the important indicators for uplink transmission is power control. Existing Power Headroom Reports (PHRs) are all designed based on the single-Panel case, and the UE can calculate a reported Power Headroom (PH) based on the last transmitted Physical Uplink Shared Channel (PUSCH) or the referenced PUSCH, after the introduction of two-Panel, how the UE reports the PHR needs to be reconsidered.

The present application discloses a solution to the above problem of uplink power control in multi-panel scenarios. It should be noted that in the description of the present application, multiple panels are only used as an exemplary application scenario or example; the present application is equally applicable to other scenarios facing similar problems, such as single-panel scenarios, or for different technical fields, such as technical fields other than uplink power control, or the field of measurement reporting, or other non-uplink power control fields such as uplink data transmission, to achieve similar technical results. Additionally, the adoption of a unified solution for various scenarios, including but not limited to multi-panel scenario, contributes to the reduction of hardcore complexity and costs. In the case of no conflict, the embodiments of a first node and the characteristics in the embodiments may be applied to a second node, and vice versa. Particularly, for interpretations of the terminology, nouns, functions and variables (unless otherwise specified) in the present application, refer to definitions given in TS36 series, TS38 series and TS37 series of 3GPP specifications.

The present application provides a method in a first node for wireless communications, comprising:
receiving a first information set, the first information set indicating a first reference signal resource set and a second reference signal resource set; and
transmitting a target signal, the target signal comprising a second information set;
herein, the second information set comprises a first power difference, or the second information set comprises a second power difference and a third power difference; the first power difference is associated with either the first reference signal resource set or the second reference signal resource set; the second power difference is associated with the first reference signal resource set, and the third power difference is associated with the second reference signal resource set; whether the target signal comprises two sub-signals that are respectively associated with the first reference signal resource set and the second reference signal resource set and are overlapping in time-frequency domain is used to determine whether the second information set comprises the first power difference or comprises both the second power difference and the third power difference.

In one embodiment, the above method is characterized in that the UE determines the content of the PHR to be reported based on the characteristics of the referenced PUSCH, reducing the overhead of the PHR, and improving the spectral efficiency.

According to one aspect of the present application, when the target signal comprises two sub-signals that are respectively associated with the first reference signal resource set and the second reference signal resource set and are overlapping in time-frequency domain, the second information set comprises the second power difference and the third power difference.

In one embodiment, the above method is characterized in that: when the referenced PUSCH is a transmission associated with a reference signal resource set, a PHR is sent for the reference signal resource set; when the referenced PUSCH is a transmission associated with two reference signal resource sets, a PHR is sent for the two reference signal resource sets.

According to one aspect of the present application, comprising:
transmitting a first signal in a first time window and transmitting a second signal in a second time window;
herein, the first signal and the second signal respectively correspond to different scheduling signalings, the first signal is associated with the first reference signal resource set, and the second signal comprises two sub-signals that are respectively associated with the first reference signal resource set and the second reference signal resource set and are overlapping in time-frequency domain; a transmission power value of the first signal is a first candidate power value, and a transmission power value of the second signal is a second candidate power value; whether the target signal comprises two sub-signals that are respectively associated with the first reference signal resource set and the second reference signal resource set and are overlapping in time-frequency domain is used to determine whether the first candidate power value or the second candidate power value is used for generating the second information set.

In one embodiment, the above method is characterized in that the target signal is the actual transmitted PUSCH.

According to one aspect of the present application, the first power difference is equal to a difference obtained by subtracting a first reference power value from a first power value, or the first power difference is equal to a difference obtained by subtracting a second reference power value from a second power value; the second power difference is equal to a difference obtained by subtracting a third reference power value from a third power value, and the third power difference is equal to a difference obtained by subtracting a fourth reference power value from a fourth power value; the first reference power value is associated with the first reference signal resource set, the second reference power value is associated with the second reference signal resource set, the third reference power value is associated with the first reference signal resource set, and the fourth reference power value is associated with the second reference signal resource set; the first reference power value or the second reference power value is a transmission power value of a first reference PUSCH, while the third reference power value and the fourth reference power value are respectively related to a transmission power value of a second reference PUSCH; the first reference PUSCH is different from the second reference PUSCH.

In one embodiment, the method is characterized in that the target signal is a PUSCH the first node refers to.

According to one aspect of the present application, comprising:
performing a channel measurement in a third reference signal resource set and performing a channel measurement in a fourth reference signal resource set; and determining that a pathloss change value set satisfies a first condition;
herein, the third reference signal resource set is associated with the first reference signal resource set, and the fourth reference signal resource set is associated with the second reference signal resource set; whether the target signal comprises two sub-signals that are respectively associated with the first reference signal resource set and the second reference signal resource set and are overlapping in time-frequency domain is used to determine whether the channel measurement performed in the third reference signal resource set and the channel measurement performed in the fourth reference signal resource set are both used for generating the pathloss change value set.

According to one aspect of the present application, when the target signal comprises only one sub-signal being associated with the first reference signal resource set, the pathloss change value set includes a first pathloss change value, and the channel measurement performed in the third reference signal resource set is used to determine the first pathloss change value, that the pathloss change value set satisfies the first condition includes that the first pathloss change value is greater than a first threshold; when the target signal comprises only one sub-signal being associated with the second reference signal resource set, the pathloss change value set includes a second pathloss change value, and the channel measurement performed in the fourth reference signal resource set is used to determine the second pathloss change value, that the pathloss change value set satisfies the first condition includes that the second pathloss change value is greater than a second threshold; when the target signal comprises two sub-signals that are respectively associated with the first reference signal resource set and the second reference signal resource set and are overlapping in time-frequency domain, the pathloss change value set includes a third pathloss change value and a fourth pathloss change value, the channel measurement performed in the third reference signal resource set is used to determine the third pathloss change value, and the channel measurement performed in the fourth reference signal resource set is used to determine the fourth pathloss change value, that the pathloss change value set satisfies the first condition includes that the third pathloss change value is greater than a third threshold and the fourth pathloss change value is greater than a fourth threshold.

In one embodiment, the method is characterized in that PHRs associated with different numbers of reference signal resource sets are targeted for different triggering criteria.

According to one aspect of the present application, the first reference signal resource set comprises a first reference signal resource, and the second reference signal resource set comprises a second reference signal resource; a reference signal transmitted in the first reference signal resource is QCL with a reference signal transmitted in a third reference signal resource in the third reference signal resource set, while a reference signal transmitted in the second reference signal resource is QCL with a reference signal transmitted in a fourth reference signal resource in the fourth reference signal resource set; a channel measurement for the third reference signal resource or a channel measurement for the fourth reference signal resource is used to determine the first power difference; a channel measurement for the third reference signal resource is used to determine the second power difference, while a channel measurement for the fourth reference signal resource is used to determine the third power difference.

The present application provides a method in a second node for wireless communications, comprising:
transmitting a first information set, the first information set indicating a first reference signal resource set and a second reference signal resource set; and
receiving a target signal, the target signal comprising a second information set;
herein, the second information set comprises a first power difference, or the second information set comprises a second power difference and a third power difference; the first power difference is associated with either the first reference signal resource set or the second reference signal resource set; the second power difference is associated with the first reference signal resource set, and the third power difference is associated with the second reference signal resource set; whether the target signal comprises two sub-signals that are respectively associated with the first reference signal resource set and the second reference signal resource set and are overlapping in time-frequency domain is used to determine whether the second information set comprises the first power difference or comprises both the second power difference and the third power difference.

According to one aspect of the present application, when the target signal comprises two sub-signals that are respectively associated with the first reference signal resource set and the second reference signal resource set and are overlapping in time-frequency domain, the second information set comprises the second power difference and the third power difference.

According to one aspect of the present application, comprising:
receiving a first signal in a first time window and receiving a second signal in a second time window;
herein, the first signal and the second signal respectively correspond to different scheduling signalings, the first signal is associated with the first reference signal resource set, and the second signal comprises two sub-signals that are respectively associated with the first reference signal resource set and the second reference signal resource set and are overlapping in time-frequency domain; a transmission power value of the first signal is a first candidate power value, and a transmission power value of the second signal is a second candidate power value; whether the target signal comprises two sub-signals that are respectively associated with the first reference signal resource set and the second reference signal resource set and are overlapping in time-frequency domain is used to determine whether the first candidate power value or the second candidate power value is used for generating the second information set.

According to one aspect of the present application, the first power difference is equal to a difference obtained by subtracting a first reference power value from a first power value, or the first power difference is equal to a difference obtained by subtracting a second reference power value from a second power value; the second power difference is equal to a difference obtained by subtracting a third reference power value from a third power value, and the third power difference is equal to a difference obtained by subtracting a fourth reference power value from a fourth power value; the first reference power value is associated with the first reference signal resource set, the second reference power value is associated with the second reference signal resource set, the third reference power value is associated with the first reference signal resource set, and the fourth reference power value is associated with the second reference signal resource set; the first reference power value or the second reference power value is a transmission power value of a first reference PUSCH, while the third reference power value and the fourth reference power value are respectively related to a transmission power value of a second reference PUSCH; the first reference PUSCH is different from the second reference PUSCH.

According to one aspect of the present application, comprising:
transmitting a reference signal in a third reference signal resource set and transmitting a reference signal in a fourth reference signal resource set;
herein, the third reference signal resource set is associated with the first reference signal resource set, and the fourth reference signal resource set is associated with the second reference signal resource set; a transmitter of the target signal is a first node; whether the target signal comprises two sub-signals that are respectively associated with the first reference signal resource set and the second reference signal resource set and are overlapping in time-frequency domain is used by the first node to determine whether the channel measurement performed in the third reference signal resource set and the channel measurement performed in the fourth reference signal resource set are both used for generating a pathloss change value set; the pathloss change value set satisfies a first condition.

According to one aspect of the present application, when the target signal comprises only one sub-signal being associated with the first reference signal resource set, the pathloss change value set includes a first pathloss change value, and the channel measurement performed in the third reference signal resource set is used to determine the first pathloss change value, that the pathloss change value set satisfies the first condition includes that the first pathloss change value is greater than a first threshold; when the target signal comprises only one sub-signal being associated with the second reference signal resource set, the pathloss change value set includes a second pathloss change value, and the channel measurement performed in the fourth reference signal resource set is used to determine the second pathloss change value, that the pathloss change value set satisfies the first condition includes that the second pathloss change value is greater than a second threshold; when the target signal comprises two sub-signals that are respectively associated with the first reference signal resource set and the second reference signal resource set and are overlapping in time-frequency domain, the pathloss change value set includes a third pathloss change value and a fourth pathloss change value, the channel measurement performed in the third reference signal resource set is used to determine the third pathloss change value, and the channel measurement performed in the fourth reference signal resource set is used to determine the fourth pathloss change value, that the pathloss change value set satisfies the first condition includes that the third pathloss change value is greater than a third threshold and the fourth pathloss change value is greater than a fourth threshold.

According to one aspect of the present application, the first reference signal resource set comprises a first reference signal resource, and the second reference signal resource set comprises a second reference signal resource; a reference signal transmitted in the first reference signal resource is QCL with a reference signal transmitted in a third reference signal resource in the third reference signal resource set, while a reference signal transmitted in the second reference signal resource is QCL with a reference signal transmitted in a fourth reference signal resource in the fourth reference signal resource set; a channel measurement for the third reference signal resource or a channel measurement for the fourth reference signal resource is used to determine the first power difference; a channel measurement for the third reference signal resource is used to determine the second power difference, while a channel measurement for the fourth reference signal resource is used to determine the third power difference.

The present application provides a first node for wireless communications, comprising:
a first receiver, receiving a first information set, the first information set indicating a first reference signal resource set and a second reference signal resource set; and
a first transmitter, transmitting a target signal, the target signal comprising a second information set;
herein, the second information set comprises a first power difference, or the second information set comprises a second power difference and a third power difference; the first power difference is associated with either the first reference signal resource set or the second reference signal resource set; the second power difference is associated with the first reference signal resource set, and the third power difference is associated with the second reference signal resource set; whether the target signal comprises two sub-signals that are respectively associated with the first reference signal resource set and the second reference signal resource set and are overlapping in time-frequency domain is used to determine whether the second information set comprises the first power difference or comprises both the second power difference and the third power difference.

The present application provides a second node for wireless communications, comprising:
a second transmitter, transmitting a first information set, the first information set indicating a first reference signal resource set and a second reference signal resource set; and
a second receiver, receiving a target signal, the target signal comprising a second information set;
herein, the second information set comprises a first power difference, or the second information set comprises a second power difference and a third power difference; the first power difference is associated with either the first reference signal resource set or the second reference signal resource set; the second power difference is associated with the first reference signal resource set, and the third power difference is associated with the second reference signal resource set; whether the target signal comprises two sub-signals that are respectively associated with the first reference signal resource set and the second reference signal resource set and are overlapping in time-frequency domain is used to determine whether the second information set comprises the first power difference or comprises both the second power difference and the third power difference.

In one embodiment, the scheme in the present application is advantageous in linking whether a PHR is associated with a single reference signal resource set or with two reference signal resource sets at the same time to the spatial characteristics of a reference PUSCH, which improves the efficiency of the PHR reporting, reduces signaling overhead, and avoids wastage of uplink resources.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of processing of a first node according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a flowchart of a target signal according to one embodiment of the present application.

FIG. 6 illustrates a flowchart of a first signal and a second signal according to one embodiment of the present application.

FIG. 7 illustrates a flowchart of channel measurement according to one embodiment of the present application.

FIG. 8 illustrates a schematic diagram of a second information set according to one embodiment of the present application.

FIG. 9 illustrates a schematic diagram of a first reference signal resource set and a second reference signal resource set according to one embodiment of the present application.

FIG. 10 illustrates a schematic diagram of a third reference signal resource set and a fourth reference signal resource set according to one embodiment of the present application.

FIG. 11 illustrates a schematic diagram of a first node according to one embodiment of the present application.

FIG. 12 illustrates a schematic diagram of antenna ports and antenna port groups according to one embodiment of the present application.

FIG. 13 illustrates a structure block diagram of a processing device in a first node according to one embodiment of the present application.

FIG. 14 illustrates a structure block diagram of a processing device in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

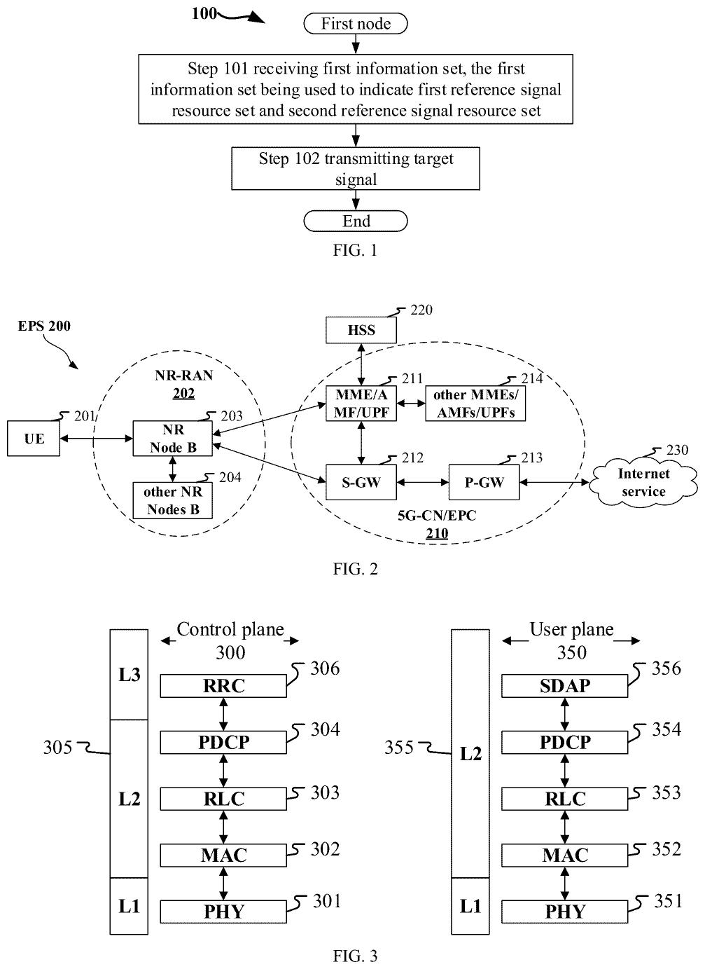

Embodiment 1 illustrates a flowchart of processing of a first node, as shown in FIG. 1. In 100 illustrated by FIG. 1, each box represents a step. In Embodiment 1, the first node in the present application receives a first information set in step 101, the first information set being used to indicate a first reference signal resource set and a second reference signal resource set; and transmits a target signal in step 102, the target signal comprising a second information set.

In Embodiment 1, the second information set comprises a first power difference, or the second information set comprises a second power difference and a third power difference; the first power difference is associated with either the first reference signal resource set or the second reference signal resource set; the second power difference is associated with the first reference signal resource set, and the third power difference is associated with the second reference signal resource set; whether the target signal comprises two sub-signals that are respectively associated with the first reference signal resource set and the second reference signal resource set and are overlapping in time-frequency domain is used to determine whether the second information set comprises the first power difference or comprises both the second power difference and the third power difference.

In one embodiment, the first information set is transmitted via a Radio Resource Control (RRC) signaling.

In one embodiment, the first information set is configured by an RRC signaling.

In one embodiment, the RRC signaling that transmits or configures the first information set comprises one or more fields in a PUSCH-PowerControl in Specification.

In one embodiment, the RRC signaling that transmits or configures the first information set comprises a PUSCH-PowerControl in Specification.

In one embodiment, the RRC signaling that transmits or configures the first information set comprises a PUSCH-P0-PUSCH-AlphaSet in Specification.

In one embodiment, the RRC signaling that transmits or configures the first information set comprises one or more fields in a SRI-PUSCH-PowerControl in Specification.

In one embodiment, the RRC signaling that transmits or configures the first information set comprises a SRI-PUSCH-PowerControl in Specification.

In one embodiment, the RRC signaling that transmits or configures the first information set comprises one or more fields in a CSI-ResourceConfig in Specification.

In one embodiment, the RRC signaling that transmits or configures the first information set comprises one or more fields in a CSI-SSB-ResourceSet in Specification.

In one embodiment, the RRC signaling that transmits or configures the first information set comprises one or more fields in a SRS-Config in Specification.

In one embodiment, the name of the RRC signaling that transmits or configures the first information set includes Power.

In one embodiment, the name of the RRC signaling that transmits or configures the first information set includes Control.

In one embodiment, the name of the RRC signaling that transmits or configures the first information set includes PUSCH.

In one embodiment, the name of the RRC signaling that transmits or configures the first information set includes Channel State Information (CSI).

In one embodiment, the name of the RRC signaling that transmits or configures the first information set includes CSI-RS.

In one embodiment, the name of the RRC signaling that transmits or configures the first information set includes SRS (i.e., Sounding Reference Signal).

In one embodiment, the name of the RRC signaling that transmits or configures the first information set includes SRI.

In one embodiment, the first reference signal resource set is identified by an SRS-ResourceSetId.

In one embodiment, the first reference signal resource set corresponds to an SRS Resource Set.

In one embodiment, the first reference signal resource set comprises one reference signal resource.

In one subembodiment, the reference signal resource included in the first reference signal resource set is an SRS Resource.

In one subembodiment, the reference signal resource included in the first reference signal resource set is a CSI-RS resource.

In one subembodiment, the reference signal resource included in the first reference signal resource set is an SSB.

In one embodiment, the first reference signal resource set comprises K1 first-type reference signal resource(s), K1 being a positive integer.

In one subembodiment, K1 is equal to 1.

In one subembodiment, K1 is greater than 1.

In one subembodiment, any one of the K1 first-type reference signal resource(s) included in the first reference signal resource set is an SRS Resource.

In one subembodiment, at least one of the K1 first-type reference signal resource(s) included in the first reference signal resource set is an SRS Resource.

In one subembodiment, any one of the K1 first-type reference signal resource(s) included in the first reference signal resource set is a CSI-RS Resource.

In one subembodiment, any one of the K1 first-type reference signal resource(s) included in the first reference signal resource set is an SSB.

In one embodiment, the second reference signal resource set is identified by an SRS-ResourceSetId.

In one embodiment, the second reference signal resource set corresponds to an SRS Resource Set.

In one embodiment, the second reference signal resource set comprises one reference signal resource.

In one subembodiment, the reference signal resource included in the second reference signal resource set is an SRS Resource.

In one subembodiment, the reference signal resource included in the second reference signal resource set is a CSI-RS resource.

In one subembodiment, the reference signal resource included in the second reference signal resource set is an SSB.

In one embodiment, the second reference signal resource set comprises K2 second-type reference signal resource(s), K2 being a positive integer.

In one subembodiment, K2 is equal to 1.

In one subembodiment, K2 is greater than 1.

In one subembodiment, any one of the K2 second-type reference signal resource(s) included in the second reference signal resource set is an SRS Resource.

In one subembodiment, at least one of the K2 second-type reference signal resource(s) included in the second reference signal resource set is an SRS Resource.

In one subembodiment, any one of the K2 second-type reference signal resource(s) included in the second reference signal resource set is a CSI-RS Resource.

In one subembodiment, any one of the K2 second-type reference signal resource(s) included in the second reference signal resource set is an SSB.

In one embodiment, a physical layer channel occupied by the target signal includes a PUSCH.

In one embodiment, a physical layer channel occupied by the target signal includes a Physical Uplink Control Channel (PUCCH).

In one embodiment, the target signal comprises Medium Access Control (MAC) Control Elements (CE).

In one embodiment, the target signal comprises a PHR, the PHR comprised in the target signal comprising one or more PH values.

In one embodiment, the first power difference is measured in dBm.

In one embodiment, the first power difference is measured in dB.

In one embodiment, the first power difference is measured in mW.

In one embodiment, the second power difference is measured in dBm.

In one embodiment, the second power difference is measured in dB.

In one embodiment, the second power difference is measured in mW.

In one embodiment, the third power difference is measured in dBm.

In one embodiment, the third power difference is measured in dB.

In one embodiment, the third power difference is measured in mW.

In one embodiment, the second information set comprises at least one power difference.

In one embodiment, the second information set generates a MAC CE.

In one embodiment, the first power difference is associated with the first reference signal resource set.

In one subembodiment, the first power difference is a corresponding PH for the first node transmitting a radio signal generated by one Transport Block (TB) only on a spatial transmission (Tx) parameter corresponding to one reference signal resource in the first reference signal resource set.

In one subembodiment, the first power difference is associated with a first reference signal resource among K1 first-type reference signal resources included in the first reference signal resource set.

In one subsidiary embodiment of the above subembodiment, the first reference signal resource is an SRS resource.

In one subsidiary embodiment of the above subembodiment, the first reference signal resource corresponds to a SRS-ResourceID.

In one subembodiment, the first power difference is equal to a difference obtained by subtracting a first target power value from a first power value, at least one of the first power value or the first target power value being associated with the first reference signal resource set.

In one subsidiary embodiment of the above subembodiment, the first power value is P_{CMAX,f,c}(i) of Specification.

In one subsidiary embodiment of the above subembodiment, the first power value is \tilde{P}_{CMAX,f,c}(i) of Specification.

In one subsidiary embodiment of the above subembodiment, the first power value is associated with the first reference signal resource set.

In one subsidiary embodiment of the above subembodiment, configuration information for the first power value includes an ID corresponding to the first reference signal resource set.

In one subsidiary embodiment of the above subembodiment, the first target power value is a power value of a radio signal transmitted by the first node only on a spatial Tx parameter corresponding to one reference signal resource in the first reference signal resource set.

In one subsidiary embodiment of the above subembodiment, the first target power value is a power value of a radio signal that the first node assumes to be transmitted only on a spatial Tx parameter corresponding to one reference signal resource in the first reference signal resource set.

In one subsidiary embodiment of the above subembodiment, the first reference signal resource in the first reference signal resource set is associated with a given CSI-RS resource, and a channel quality obtained for a radio signal measured in the given CSI-RS resource is used to determine the first target power value, the channel quality including a pathloss.

In one subsidiary embodiment of the above subembodiment, the first reference signal resource in the first reference signal resource set is associated with a given SSB, and a channel quality obtained for a radio signal measured in the given SSB is used to determine the first target power value, the channel quality including a pathloss.

In one embodiment, the first power difference is associated with the second reference signal resource set.

In one subembodiment, the first power difference is a corresponding PH for the first node transmitting a radio signal generated by one TB only on a spatial transmission (Tx) parameter corresponding to one reference signal resource in the second reference signal resource set.

In one subembodiment, the first power difference is associated with a second reference signal resource among K2 second-type reference signal resources included in the second reference signal resource set.

In one subsidiary embodiment of the above subembodiment, the second reference signal resource is an SRS resource.

In one subsidiary embodiment of the above subembodiment, the second reference signal resource corresponds to a SRS-ResourceID.

In one subembodiment, the first power difference is equal to a difference obtained by subtracting a second target power value from a second power value, at least one of the second power value or the second target power value being associated with the second reference signal resource set.

In one subsidiary embodiment of the above subembodiment, the second power value is P_{CMAX,f,c}(i) of Specification.

In one subsidiary embodiment of the above subembodiment, the second power value is \tilde{P}_{CMAX,f,c}(i) of Specification.

In one subsidiary embodiment of the above subembodiment, the second power value is associated with the second reference signal resource set.

In one subsidiary embodiment of the above subembodiment, configuration information for the second power value includes an ID corresponding to the second reference signal resource set.

In one subsidiary embodiment of the above subembodiment, the second target power value is a power value of a radio signal transmitted by the first node only on a spatial Tx parameter corresponding to one reference signal resource in the second reference signal resource set.

In one subsidiary embodiment of the above subembodiment, the second target power value is a power value of a radio signal that the first node assumes to be transmitted only on a spatial Tx parameter corresponding to one reference signal resource in the second reference signal resource set.

In one subsidiary embodiment of the above subembodiment, the second reference signal resource in the second reference signal resource set is associated with a given CSI-RS resource, and a channel quality obtained for a radio signal measured in the given CSI-RS resource is used to determine the second target power value, the channel quality including a pathloss.

In one subsidiary embodiment of the above subembodiment, the second reference signal resource in the second reference signal resource set is associated with a given SSB, and a channel quality obtained for a radio signal measured in the given SSB is used to determine the second target power value, the channel quality including a pathloss.

In one embodiment, the second power difference is associated with the first reference signal resource set and the third power difference is associated with the second reference signal resource set.

In one subembodiment, the second information set comprises both the second power difference and the third power difference.

In one subembodiment, the second power difference and the third power difference are two PHs respectively corresponding to the first node transmitting two radio signals generated by two TBs simultaneously on a spatial transmission parameter corresponding to one reference signal resource in the first reference signal resource set and a spatial transmission parameter corresponding to one reference signal resource in the second reference signal resource set.

In one subembodiment, the second power difference is associated with a fifth reference signal resource among the K1 first-type reference signal resources included in the first reference signal resource set, and the third power difference is associated with a sixth reference signal resource among the K2 second-type reference signal resources included in the second reference signal resource set.

In one subsidiary embodiment of the above subembodiment, the fifth reference signal resource is the same as the first reference signal resource.

In one subsidiary embodiment of the above subembodiment, the sixth reference signal resource is the same as the second reference signal resource.

In one subsidiary embodiment of the above subembodiment, the fifth reference signal resource is difference from the first reference signal resource.

In one subsidiary embodiment of the above subembodiment, the sixth reference signal resource is different from the second reference signal resource.

In one subsidiary embodiment of the above subembodiment, the fifth reference signal resource is an SRS resource.

In one subsidiary embodiment of the above subembodiment, the fifth reference signal resource corresponds to a SRS-ResourceID.

In one subsidiary embodiment of the above subembodiment, the sixth reference signal resource is an SRS resource.

In one subsidiary embodiment of the above subembodiment, the sixth reference signal resource corresponds to a SRS-ResourceID.

In one subembodiment, the second power difference is equal to a difference obtained by subtracting a third target power value from a third power value, and the third power difference is equal to a difference obtained by subtracting a fourth target power value from a fourth power value; at least one of the third power value or the third target power value is associated with the first reference signal resource set, and at least one of the fourth power value or the fourth target power value is associated with the second reference signal resource set.

In one subsidiary embodiment of the above subembodiment, the third power value is P_{CMAX,f,c}(i) of Specification.

In one subsidiary embodiment of the above subembodiment, the third power value is \tilde{P}_{CMAX,f,c}(i) of Specification.

In one subsidiary embodiment of the above subembodiment, the third power value is associated with the first reference signal resource set.

In one subsidiary embodiment of the above subembodiment, configuration information for the third power value includes an ID corresponding to the first reference signal resource set.

In one subsidiary embodiment of the above subembodiment, the third power value is different from the first power value.

In one subsidiary embodiment of the above subembodiment, the third power value and the first power value are each independently configured.

In one subsidiary embodiment of the above subembodiment, the fourth power value is P_{CMAX,f,c}(i) of Specification.

In one subsidiary embodiment of the above subembodiment, the fourth power value is \tilde{P}_{CMAX,f,c}(i) of Specification.

In one subsidiary embodiment of the above subembodiment, the fourth power value is associated with the second reference signal resource set.

In one subsidiary embodiment of the above subembodiment, configuration information for the fourth power value includes an ID corresponding to the second reference signal resource set.

In one subsidiary embodiment of the above subembodiment, the fourth power value is different from the second power value.

In one subsidiary embodiment of the above subembodiment, the fourth power value and the second power value are each independently configured.

In one subsidiary embodiment of the above subembodiment, the third target power value and the fourth target power value are power values respectively used for the first node transmitting two radio sub-signals simultaneously on a spatial transmission parameter corresponding to one reference signal resource in the first reference signal resource set and on a spatial transmission parameter corresponding to one reference signal resource in the second reference signal resource set.

In one subsidiary embodiment of the above subembodiment, the third target power value and the fourth target power value are power values respectively used for the first node assuming to be transmitting two radio sub-signals simultaneously on a spatial transmission parameter corresponding to one reference signal resource in the first reference signal resource set and on a spatial transmission parameter corresponding to one reference signal resource in the second reference signal resource set.

In one subsidiary embodiment of the above subembodiment, the fifth reference signal resource in the first reference signal resource set is associated with a given CSI-RS resource, and a channel quality obtained for a radio signal measured in the given CSI-RS resource is used to determine the third target power value, the channel quality including a pathloss.

In one subsidiary embodiment of the above subembodiment, the fifth reference signal resource in the first reference signal resource set is associated with a given SSB, and a channel quality obtained for a radio signal measured in the given SSB is used to determine the third target power value, the channel quality including a pathloss.

In one subsidiary embodiment of the above subembodiment, the sixth reference signal resource in the second reference signal resource set is associated with a given CSI-RS resource, and a channel quality obtained for a radio signal measured in the given CSI-RS resource is used to determine the fourth target power value, the channel quality including a pathloss.

In one subsidiary embodiment of the above subembodiment, the sixth reference signal resource in the second reference signal resource set is associated with a given SSB, and a channel quality obtained for a radio signal measured in the given SSB is used to determine the fourth target power value, the channel quality including a pathloss.

In one embodiment, when the target signal does not comprise two sub-signals that are respectively associated with the first reference signal resource set and the second reference signal resource set and are overlapping in time-frequency domain, the second information set comprises only the first power difference of the first power difference, the second power difference and the third power difference, and both the target signal and the first power difference are associated with the first reference signal resource set or the second reference signal resource set.

In one embodiment, when the target signal does not comprise two sub-signals that are respectively associated with the first reference signal resource set and the second reference signal resource set and are overlapping in time-frequency domain, the target signal comprises only one sub-signal that is associated with one of the first reference signal resource set or the second reference signal resource set.

In one embodiment, a physical layer channel occupied by one of the sub-signals of this application includes a PUSCH.

In one embodiment, one of the sub-signals of this application is generated by one TB.

In one embodiment, one of the sub-signals of this application occupies a Hybrid Automatic Repeat reQuest (HARQ) process number.

In one embodiment, one of the sub-signals of this application occupies a PUSCH.

In one embodiment, the channel quality in the present application comprises a pathloss.

In one embodiment, the channel quality in the present application comprises a Reference Signal Received Power (RSRP).

In one embodiment, the channel quality in the present application comprises at least one of a Reference Signal Received Quality (RSRQ), a Received Signal Strength Indicator (RSSI), a Signal-to-noise ratio (SNR) or a Signal to Interference plus Noise Ratio (SINR).

In one embodiment, when the target signal does not comprise two sub-signals that are respectively associated with the first reference signal resource set and the second reference signal resource set and are overlapping in time-frequency domain, sub-signal(s) comprised in the target signal is/are associated with the first reference signal resource set or the second reference signal resource set.

In one subembodiment, when the sub-signal(s) comprised in the target signal is/are associated with the first reference signal resource set, one first-type reference signal resource in the first reference signal resource set is used to determine a spatial transmission parameter of the sub-signal(s).

In one subembodiment, when the sub-signal(s) comprised in the target signal is/are associated with the first reference signal resource set, a reference signal transmitted in one first-type reference signal resource in the first reference signal resource set and the sub-signal(s) are Quasi-Colocated (QCL).

In one subembodiment, when the sub-signal(s) comprised in the target signal is/are associated with the second reference signal resource set, one second-type reference signal resource in the second reference signal resource set is used to determine a spatial transmission parameter of the sub-signal(s).

In one subembodiment, when the sub-signal(s) comprised in the target signal is/are associated with the second reference signal resource set, a reference signal transmitted in one second-type reference signal resource in the second reference signal resource set and the sub-signal(s) are QCL.

In one embodiment, when the target signal comprises two sub-signals that are respectively associated with the first reference signal resource set and the second reference signal resource set and are overlapping in time-frequency domain, the two sub-signals comprised in the target signal are each associated with the first reference signal resource set or the second reference signal resource set.

In one subembodiment, one first-type reference signal resource in the first reference signal resource set and one second-type reference signal resource in the second reference signal resource set are respectively used to determine spatial transmission parameters of the two sub-signals comprised in the target signal.

In one subembodiment, a reference signal transmitted in one first-type reference signal resource in the first reference signal resource set and a reference signal transmitted in one second-type reference signal resource in the second reference signal resource set are respectively QCL with the two sub-signals comprised in the target signal.

In one embodiment, the first power difference is associated with the first reference signal resource set when the target signal comprises only one sub-signal that is associated with the first reference signal resource set.

In one embodiment, the first power difference is associated with the second reference signal resource set when the target signal comprises only one sub-signal that is associated with the second reference signal resource set.

### Embodiment 2

Embodiment 2 illustrates a schematic diagram of a network architecture, as shown in FIG. 2.

FIG. 2 is a diagram illustrating a network architecture 200 of 5G NR, Long-Term Evolution (LTE) and Long-Term Evolution Advanced (LTE-A) systems. The 5G NR or LTE network architecture 200 may be called an Evolved Packet System (EPS) 200 or other suitable terminology. The EPS 200 may comprise one UE 201, an NR-RAN 202, an Evolved Packet Core (EPC)/5G-Core Network (5G-CN) 210, a Home Subscriber Server (HSS) 220 and an Internet Service 230. The EPS 200 may be interconnected with other access networks. For simple description, the entities/interfaces are not shown. As shown in FIG. 2, the EPS 200 provides packet switching services. Those skilled in the art will find it easy to understand that various concepts presented throughout the present application can be extended to networks providing circuit switching services or other cellular networks. The NR-RAN 202 comprises an NR node B (gNB) 203 and other gNBs 204. The gNB 203 provides UE 201 oriented user plane and control plane terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the EPC/5G-CN 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the EPC/5G-CN 210 via an S1/NG interface. The EPC/5G-CN 210 comprises a Mobility Management Entity (MME)/Authentication Management Field (AMF)/User Plane Function (UPF) 211, other MMEs/AMFs/UPFs 214, a Service Gateway (S-GW) 212 and a Packet Date Network Gateway (P-GW) 213. The MME/AMF/UPF 211 is a control node for processing a signaling between the UE 201 and the EPC/5G-CN 210. Generally, the MME/AMF/UPF 211 provides bearer and connection management. All user Internet Protocol (IP) packets are transmitted through the S-GW 212. The S-GW 212 is connected to the P-GW 213. The P-GW 213 provides UE IP address allocation and other functions. The P-GW 213 is connected to the Internet Service 230. The Internet Service 230 comprises IP services corresponding to operators, specifically including Internet, Intranet, IP Multimedia Subsystem (IMS) and Packet Switching Streaming (PSS) services.

In one embodiment, the UE 201 corresponds to the first node in the present application.

In one embodiment, the UE201 supports simultaneous transmitting of multiple Panels.

In one embodiment, the UE201 supports multi-Panel-based power sharing.

In one embodiment, the UE201 supports multiple uplink Radio Frequencies (RFs).

In one embodiment, the UE201 supports multiple uplink RFs to be transmitted simultaneously.

In one embodiment, the UE201 supports reporting of multiple UE capability value sets.

In one embodiment, the NR node B corresponds to the second node in the present application.

In one embodiment, the NR node B supports receiving signals from multiple Panels of a terminal simultaneously.

In one embodiment, the NR node B supports receiving signals sent by multiple uplink Radio Frequencies (RFs) from the same terminal.

In one embodiment, the NR node B is a base station.

In one embodiment, the NR node B is a cell.

In one embodiment, the NR node B comprises multiple cells.

In one embodiment, the first node in the present application corresponds to the UE201, and the second node in the present application corresponds to the NR node B.

### Embodiment 3

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 between a first communication node (UE, gNB or, RSU in V2X) and a second communication node (gNB, UE, or RSU in V2X), is represented by three layers, i.e., layer 1, layer 2 and layer 3. The layer 1 (L1) is the lowest layer which performs signal processing functions of various PHY layers. The L1 is called PHY 301 in the present application. The layer 2 (L2) 305 is above the PHY 301, and is in charge of the link between a first communication node and a second communication node via the PHY 301. The L2 305 comprises a Medium Access Control (MAC) sublayer 302, a Radio Link Control (RLC) sublayer 303 and a Packet Data Convergence Protocol (PDCP) sublayer 304. All these sublayers terminate at the second communication nodes. The PDCP sublayer 304 provides multiplexing among variable radio bearers and logical channels. The PDCP sublayer 304 provides security by encrypting packets and also support for inter-cell handover of the second communication node between first communication nodes. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. In the control plane 300, The RRC sublayer 306 in the L3 layer is responsible for acquiring radio resources (i.e., radio bearer) and configuring the lower layer using an RRC signaling between the second communication node and the first communication node. The radio protocol architecture in the user plane 350 comprises the L1 layer and the L2 layer. In the user plane 350, the radio protocol architecture used for the first communication node and the second communication node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics. Although not described in FIG. 3, the first communication node may comprise several higher layers above the L2 355, such as a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the PDCP304 of the second communication node is used for generating scheduling of the first communication node.

In one embodiment, the PDCP354 of the second communication node is used for generating scheduling of the first communication node.

In one embodiment, the first information set is generated by the MAC302 or the MAC352.

In one embodiment, the first information set is generated by the RRC 306.

In one embodiment, the second information set is generated by the MAC302 or the MAC352.

In one embodiment, the second information set is generated by the RRC 306.

In one embodiment, the target signal is generated by the PHY 301 or the PHY 351.

In one embodiment, the target signal is generated by the MAC302 or the MAC352.

In one embodiment, the target signal is generated by the RRC 306.

In one embodiment, the first signal is generated by the PHY 301 or the PHY 351.

In one embodiment, the first signal is generated by the MAC302 or the MAC352.

In one embodiment, the first signal is generated by the RRC 306.

In one embodiment, the second signal is generated by the PHY 301, or the PHY 351.

In one embodiment, the second signal is generated by the MAC302 or the MAC352.

In one embodiment, the second signal is generated by the RRC 306.

In one embodiment, the reference signal transmitted in the first reference signal resource set is generated by the PHY 301 or the PHY 351.

In one embodiment, the reference signal transmitted in the first reference signal resource set is generated by the MAC302 or the MAC352.

In one embodiment, the reference signal transmitted in the first reference signal resource set is generated by the RRC306.

In one embodiment, the reference signal transmitted in the second reference signal resource set is generated by the PHY 301 or the PHY 351.

In one embodiment, the reference signal transmitted in the second reference signal resource set is generated by the MAC302 or the MAC352.

In one embodiment, the reference signal transmitted in the second reference signal resource set is generated by the RRC306.

In one embodiment, the reference signal transmitted in the third reference signal resource set is generated by the PHY 301 or the PHY 351.

In one embodiment, the reference signal transmitted in the third reference signal resource set is generated by the MAC302 or the MAC352.

In one embodiment, the reference signal transmitted in the third reference signal resource set is generated by the RRC306.

In one embodiment, the reference signal transmitted in the fourth reference signal resource set is generated by the PHY 301 or the PHY 351.

In one embodiment, the reference signal transmitted in the fourth reference signal resource set is generated by the MAC302 or the MAC352.

In one embodiment, the reference signal transmitted in the fourth reference signal resource set is generated by the RRC306.

In one embodiment, the first node is a terminal.

In one embodiment, the first node is a relay.

In one embodiment, the second node is a relay.

In one embodiment, the second node is a base station.

In one embodiment, the second node is a gNB.

In one embodiment, the second node is a Transmitter Receiver Point (TRP).

In one embodiment, the second node is used for managing multiple TRPs.

In one embodiment, the second node is used for managing multiple nodes of cells.

### Embodiment 4

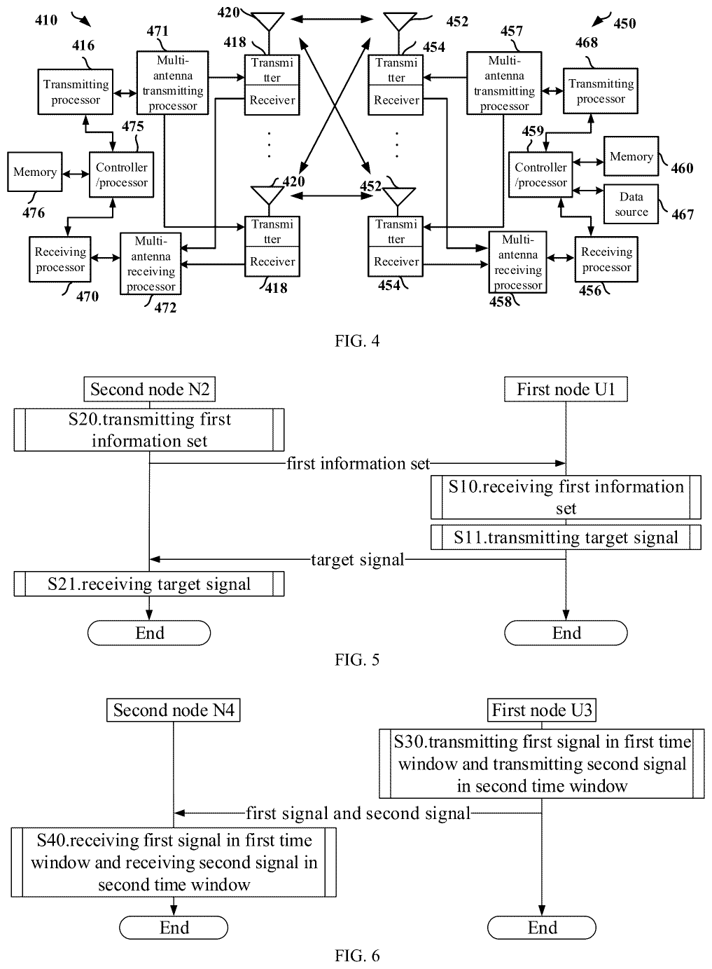

Embodiment 4 illustrates a schematic diagram of a first communication device and a second communication device according to the present application, as shown in FIG. 4. FIG. 4 is a block diagram of a first communication device 450 and a second communication device 410 in communication with each other in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the second communication device 410, a higher layer packet from a core network is provided to the controller/processor 475. The controller/processor 475 provides functions of the L2 layer. In the transmission from the second communication device 410 to the first communication device 450, the controller/processor 475 provides header compression, encryption, packet segmentation and reordering, and multiplexing between a logical channel and a transport channel, and radio resource allocation of the first communication device 450 based on various priorities. The controller/processor 475 is also in charge of a retransmission of a lost packet and a signaling to the first communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 410 side and the mapping to signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the second communication device 410 to the first communication device 450, at the first communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts the processed baseband multicarrier symbol stream from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any first communication device 450-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted by the second communication device 410 on the physical channel. Next, the higher-layer data and control signal are provided to the controller/processor 459. The controller/processor 459 provides functions of the L2 layer. The controller/processor 459 can be associated with the memory 460 that stores program code and data; the memory 460 may be called a computer readable medium. In the transmission from the second communication device 410 to the second communication device 450, the controller/processor 459 provides demultiplexing between a transport channel and a logical channel, packet reassembling, decrypting, header decompression and control signal processing so as to recover a higher-layer packet from the core network. The higher-layer packet is later provided to all protocol layers above the L2 layer. Or various control signals can be provided to the L3 for processing.

In a transmission from the first communication device 450 to the second communication device 410, at the first communication device 450, the data source 467 is configured to provide a higher-layer packet to the controller/processor 459. The data source 467 represents all protocol layers above the L2 layer. Similar to a transmitting function of the second communication device 410 described in the transmission from the second communication node 410 to the first communication node 450, the controller/processor 459 performs header compression, encryption, packet segmentation and reordering, and multiplexing between a logical channel and a transport channel based on radio resource allocation so as to provide the L2 layer functions used for the user plane and the control plane. The controller/processor 459 is also responsible for a retransmission of a lost packet, and a signaling to the second communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 firstly converts a baseband symbol stream provided by the multi-antenna transmitting processor 457 into a radio frequency symbol stream, and then provides the radio frequency symbol stream to the antenna 452.

In a transmission from the first communication device 450 to the second communication device 410, the function of the second communication device 410 is similar to the receiving function of the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data; the memory 476 may be called a computer readable medium. In the transmission from the first communication device 450 to the second communication device 410, the controller/processor 475 provides de-multiplexing between a transport channel and a logical channel, packet reassembling, decrypting, header decompression, control signal processing so as to recover a higher-layer packet from the first communication device (UE) 450. The higher-layer packet coming from the controller/processor 475 may be provided to the core network.

In one embodiment, the first communication device 450 comprises at least one processor and at least one memory. The at least one memory comprises computer program codes; the at least one memory and the computer program codes are configured to be used in collaboration with the at least one processor. The first communication device 450 at least firstly receives a first information set, the first information set indicating a first reference signal resource set and a second reference signal resource set; and then transmits a target signal, the target signal comprising a second information set; the second information set comprises a first power difference, or the second information set comprises a second power difference and a third power difference; the first power difference is associated with either the first reference signal resource set or the second reference signal resource set; the second power difference is associated with the first reference signal resource set, and the third power difference is associated with the second reference signal resource set; whether the target signal comprises two sub-signals that are respectively associated with the first reference signal resource set and the second reference signal resource set and are overlapping in time-frequency domain is used to determine whether the second information set comprises the first power difference or comprises both the second power difference and the third power difference.

In one embodiment, the first communication device 450 comprises a memory that stores a computer readable instruction program. The computer readable instruction program generates actions when executed by at least one processor. The actions include: firstly receiving a first information set, the first information set indicating a first reference signal resource set and a second reference signal resource set; and then transmitting a target signal, the target signal comprising a second information set; the second information set comprises a first power difference, or the second information set comprises a second power difference and a third power difference; the first power difference is associated with either the first reference signal resource set or the second reference signal resource set; the second power difference is associated with the first reference signal resource set, and the third power difference is associated with the second reference signal resource set; whether the target signal comprises two sub-signals that are respectively associated with the first reference signal resource set and the second reference signal resource set and are overlapping in time-frequency domain is used to determine whether the second information set comprises the first power difference or comprises both the second power difference and the third power difference.

In one embodiment, the second communication device 410 comprises at least one processor and at least one memory. The at least one memory comprises computer program codes; the at least one memory and the computer program codes are configured to be used in collaboration with the at least one processor. The second communication device 410 at least firstly transmits a first information set, the first information set indicating a first reference signal resource set and a second reference signal resource set; and then receives a target signal, the target signal comprising a second information set; the second information set comprises a first power difference, or the second information set comprises a second power difference and a third power difference; the first power difference is associated with either the first reference signal resource set or the second reference signal resource set; the second power difference is associated with the first reference signal resource set, and the third power difference is associated with the second reference signal resource set; whether the target signal comprises two sub-signals that are respectively associated with the first reference signal resource set and the second reference signal resource set and are overlapping in time-frequency domain is used to determine whether the second information set comprises the first power difference or comprises both the second power difference and the third power difference.

In one embodiment, the second communication device 410 comprises a memory that stores a computer readable instruction program. The computer readable instruction program generates actions when executed by at least one processor. The actions include: firstly transmitting a first information set, the first information set indicating a first reference signal resource set and a second reference signal resource set; and then receiving a target signal, the target signal comprising a second information set; the second information set comprises a first power difference, or the second information set comprises a second power difference and a third power difference; the first power difference is associated with either the first reference signal resource set or the second reference signal resource set; the second power difference is associated with the first reference signal resource set, and the third power difference is associated with the second reference signal resource set; whether the target signal comprises two sub-signals that are respectively associated with the first reference signal resource set and the second reference signal resource set and are overlapping in time-frequency domain is used to determine whether the second information set comprises the first power difference or comprises both the second power difference and the third power difference.

In one embodiment, the first communication device 450 corresponds to the first node in the present application.

In one embodiment, the second communication device 410 corresponds to the second node in the present application.

In one embodiment, the first communication device 450 is a UE.

In one embodiment, the first communication device 450 is a terminal.

In one embodiment, the first communication device 450 is a relay.

In one embodiment, the second communication device 410 is a base station.

In one embodiment, the second communication device 410 is a relay.

In one embodiment, the second communication device 410 is network equipment.

In one embodiment, the second communication device 410 is a serving cell.

In one embodiment, the second communication device 410 is a TRP.

In one embodiment, at least the first four of the antenna 452, the receiver 454, the multi-antenna receiving processor 458, the receiving processor 456, and the controller/processor 459 are used for receiving a first information set; at least the first four of the antenna 420, the transmitter 418, the multi-antenna transmitting processor 471, the transmitting processor 416 and the controller/processor 475 are used for transmitting a first information set.

In one embodiment, at least the first four of the antenna 452, the transmitter 454, the multi-antenna transmitting processor 457, the transmitting processor 468 and the controller/processor 459 are used to transmit a target signal; at least the first four of the antenna 420, the receiver 418, the multi-antenna receiving processor 472, the receiving processor 470 and the controller/processor 475 are used to receive a target signal.

In one embodiment, at least the first four of the antenna 452, the transmitter 454, the multi-antenna transmitting processor 457, the transmitting processor 468 and the controller/processor 459 are used to transmit a first signal in a first time window and transmit a second signal in a second time window; at least the first four of the antenna 420, the receiver 418, the multi-antenna receiving processor 472, the receiving processor 470 and the controller/processor 475 are used to receive a first signal in a first time window and receive a second signal in a second time window.

In one embodiment, at least the first four of the antenna 452, the receiver 454, the multi-antenna receiving processor 458, the receiving processor 456, and the controller/processor 459 are used for performing a channel measurement in a third reference signal resource set and performing a channel measurement in a fourth reference signal resource set; and determining that a pathloss change value set satisfies a first condition; at least the first four of the antenna 420, the transmitter 418, the multi-antenna transmitting processor 471, the transmitting processor 416 and the controller/processor 475 are used for transmitting a reference signal in a third reference signal resource set and transmitting a reference signal in a fourth reference signal resource set.

### Embodiment 5

Embodiment 5 illustrates a flowchart of a target signal, as shown in FIG. 5. In FIG. 5, a first node U1 and a second node N2 are in communication via a radio link. It should be particularly noted that the sequence illustrated herein does not set any limit to the signal transmission order or implementation order in the present application. In case of no conflict, the embodiments, sub-embodiments, and subsidiary embodiments in Embodiment 5 can be applied to any of Embodiments 6 or 7; conversely, in case of no conflict, the embodiments, sub-embodiments, and subsidiary embodiments in any of Embodiments 6 or 7 can be applied to Embodiment 5.

The first node U1 receives a first information set in step S10; and transmits a target signal in step S11.

The second node N2 transmits a first information set in step S20; and receives a target signal in step S21.

In Embodiment 5, the first information set is used to indicate a first reference signal resource set and a second reference signal resource set; the target signal comprises a second information set; the second information set comprises a first power difference, or the second information set comprises a second power difference and a third power difference; the first power difference is associated with either the first reference signal resource set or the second reference signal resource set; the second power difference is associated with the first reference signal resource set, and the third power difference is associated with the second reference signal resource set; whether the target signal comprises two sub-signals that are respectively associated with the first reference signal resource set and the second reference signal resource set and are overlapping in time-frequency domain is used to determine whether the second information set comprises the first power difference or comprises both the second power difference and the third power difference.

Typically, when the target signal does not comprise two sub-signals that are respectively associated with the first reference signal resource set and the second reference signal resource set and are overlapping in time-frequency domain, the second information set comprises only the first power difference of the first power difference, the second power difference and the third power difference, and both the target signal and the first power difference are associated with a same reference signal resource set of the first reference signal resource set or the second reference signal resource set.

Typically, when the target signal does not comprise two sub-signals that are respectively associated with the first reference signal resource set and the second reference signal resource set and are overlapping in time-frequency domain, the target signal comprises only one sub-signal that is associated with one of the first reference signal resource set or the second reference signal resource set.

Typically, when the target signal comprises two sub-signals that are respectively associated with the first reference signal resource set and the second reference signal resource set and are overlapping in time-frequency domain, the second information set comprises the second power difference and the third power difference.

In one embodiment, when the target signal comprises two sub-signals that are respectively associated with the first reference signal resource set and the second reference signal resource set and are overlapping in time-frequency domain, the two sub-signals comprised in the target signal are Spatial Division Multiplexing (SDM).

In one embodiment, when the target signal comprises two sub-signals that are respectively associated with the first reference signal resource set and the second reference signal resource set and are overlapping in time-frequency domain, the two sub-signals comprised in the target signal occupy the same time-domain resource.

In one embodiment, when the target signal comprises two sub-signals that are respectively associated with the first reference signal resource set and the second reference signal resource set and are overlapping in time-frequency domain, the two sub-signals comprised in the target signal occupy the same frequency-domain resource.

In one embodiment, when the target signal comprises two sub-signals that are respectively associated with the first reference signal resource set and the second reference signal resource set and are overlapping in time-frequency domain, the two sub-signals comprised in the target signal occupy the same Resource Elements (REs).

In one embodiment, when the target signal comprises two sub-signals that are respectively associated with the first reference signal resource set and the second reference signal resource set and are overlapping in time-frequency domain, the two sub-signals comprised in the target signal are respectively generated by two different TBs.

Typically, the first power difference is equal to a difference obtained by subtracting a first reference power value from a first power value, or the first power difference is equal to a difference obtained by subtracting a second reference power value from a second power value; the second power difference is equal to a difference obtained by subtracting a third reference power value from a third power value, and the third power difference is equal to a difference obtained by subtracting a fourth reference power value from a fourth power value; the first reference power value is associated with the first reference signal resource set, the second reference power value is associated with the second reference signal resource set, the third reference power value is associated with the first reference signal resource set, and the fourth reference power value is associated with the second reference signal resource set; the first reference power value or the second reference power value is a transmission power value of a first reference PUSCH, while the third reference power value and the fourth reference power value are respectively related to a transmission power value of a second reference PUSCH; the first reference PUSCH is different from the second reference PUSCH.

In one embodiment, the phrase that the first reference PUSCH is different from the second reference PUSCH includes that the first reference PUSCH corresponds to a PUSCH generated by one TB and the second reference PUSCH corresponds to a PUSCH generated by two TBs.

In one embodiment, the phrase that the first reference PUSCH is different from the second reference PUSCH includes that the first node assumes that the first reference PUSCH is transmitted through one Panel, and the first node assumes that the second reference PUSCH is transmitted through two Panels.

In one embodiment, the phrase that the first reference PUSCH is different from the second reference PUSCH includes that the first node assumes that the first reference PUSCH is associated with one of the first reference signal resource set or the second reference signal resource set, and the first node assumes that the second reference PUSCH is associated with both the first reference signal resource set and the second reference signal resource set.

In one embodiment, when the target signal comprises only one sub-signal that is associated with the first reference signal resource set, the first power difference is equal to a difference obtained by subtracting a first reference power value from a first power value, the first reference power value is associated with the first reference signal resource set, and a given first-type reference signal resource among the K1 first-type reference signal resources included in the first reference signal resource set is associated with the first reference power value; the given first-type reference signal resource is predefined, or the position of the given first-type reference signal resource among the K1 first-type reference signal resources is fixed.

In one subembodiment, P_{O_NOMINAL_PUSCH,f,c}(j) associated with the given first-type reference signal resource is used to determine the first reference power value.

In one subembodiment, the PUSCH-AlphaSetId associated with the given first-type reference signal resource is used to determine the first reference power value.

In one subembodiment, the pusch-PathlossReferenceRS-Id used for calculating the pathloss employed for the first reference power value corresponds to the CSI-RS resource or SSB associated with the given first-type reference signal resource.

In one embodiment, when the target signal comprises only one sub-signal that is associated with the second reference signal resource set, the first power difference is equal to a difference obtained by subtracting a second reference power value from a second power value, the second reference power value is associated with the second reference signal resource set, and a given second-type reference signal resource among the K2 second-type reference signal resources included in the second reference signal resource set is associated with the second reference power value; the given second-type reference signal resource is predefined, or the position of the given second-type reference signal resource among the K2 second-type reference signal resources is fixed.

In one subembodiment, P_{O_NOMINAL_PUSCH,f,c}(j) associated with the given second-type reference signal resource is used to determine the second reference power value.

In one subembodiment, the PUSCH-AlphaSetId associated with the given second-type reference signal resource is used to determine the second reference power value.

In one subembodiment, the pusch-PathlossReferenceRS-Id used for calculating the pathloss employed for the first reference power value corresponds to the CSI-RS resource or SSB associated with the given second-type reference signal resource.

In one embodiment, when the target signal comprises two sub-signals that are respectively associated with the first reference signal resource set and the second reference signal resource set and are overlapping in time-frequency domain; the third reference power value is associated with the first reference signal resource set, and a given first-type reference signal resource among the K1 first-type reference signal resources included in the first reference signal resource set is associated with the third reference power value, the given first-type reference signal resource is predefined, or the position of the given first-type reference signal resource among the K1 first-type reference signal resources is fixed; the fourth reference power value is associated with the second reference signal resource set, and a given second-type reference signal resource among the K2 second-type reference signal resources included in the second reference signal resource set is associated with the fourth reference power value, the given second-type reference signal resource is predefined, or the position of the given second-type reference signal resource among the K2 second-type reference signal resources is fixed.

In one subembodiment, P_{O_NOMINAL_PUSCH,f,c}(j) associated with the given first-type reference signal resource is used to determine the third reference power value, while P_{O_NOMINAL_PUSCH,f,c}(j) associated with the given second-type reference signal resource is used to determine the fourth reference power value.

In one subembodiment, the PUSCH-AlphaSetId associated with the given first-type reference signal resource is used to determine the third reference power value, while the PUSCH-AlphaSetId associated with the given second-type reference signal resource is used to determine the fourth reference power value.

In one subembodiment, the pusch-PathlossReferenceRS-Id used for calculating the pathloss employed for the third reference power value corresponds to the CSI-RS resource or SSB associated with the given first-type reference signal resource, while the pusch-PathlossReferenceRS-Id used for calculating the pathloss employed for the fourth reference power value corresponds to the CSI-RS resource or SSB associated with the given second-type reference signal resource.

### Embodiment 6

Embodiment 6 illustrates a flowchart of a first signal and a second signal, as shown in FIG. 6. In FIG. 6, a first node U3 and a second node N4 are in communication via a radio link. It should be particularly noted that the sequence illustrated herein does not set any limit to the signal transmission order or implementation order in the present application. In case of no conflict, the embodiments, sub-embodiments, and subsidiary embodiments in Embodiment 6 can be applied to any of Embodiments 5 or 7; conversely, in case of no conflict, the embodiments, sub-embodiments, and subsidiary embodiments in any of Embodiments 5 or 7 can be applied to Embodiment 6.

The first node U3 transmits a first signal in a first time window and transmits a second signal in a second time window in step S30.

The second node N4 receives a first signal in a first time window and receives a second signal in a second time window in step S40.

In Embodiment 6, the first signal and the second signal respectively correspond to different scheduling signalings, the first signal is associated with the first reference signal resource set, and the second signal comprises two sub-signals that are respectively associated with the first reference signal resource set and the second reference signal resource set and are overlapping in time-frequency domain; a transmission power value of the first signal is a first candidate power value, and a transmission power value of the second signal is a second candidate power value; whether the target signal comprises two sub-signals that are respectively associated with the first reference signal resource set and the second reference signal resource set and are overlapping in time-frequency domain is used to determine whether the first candidate power value or the second candidate power value is used for generating the second information set.

In one embodiment, the first time window and the second time window are overlapping in time domain.

In one embodiment, the first time window and the second time window are orthogonal in time domain.

In one embodiment, the first time window and the second time window are both earlier in the time domain than the time-domain resource occupied by the target signal.

In one embodiment, the duration of the first time window is different from the duration of the second time window.

In one embodiment, the first time window is for reporting of a PHR with one of the first reference signal resource set or the second reference signal resource set being used for uplink transmitting.

In one embodiment, the second time window is for reporting of a PHR with the first reference signal resource set and the second reference signal resource set being both used for uplink transmitting.

In one embodiment, the first signal and the second signal are each scheduled by a different DCI (i.e., Downlink Control Information).

In one embodiment, the first signal and the second signal are each indicated by a different DCI.

In one embodiment, the first signal is QCL with a reference signal transmitted in one first-type reference signal resource in the first reference signal resource set, or the first signal is QCL with a reference signal transmitted in one second-type reference signal resource in the second reference signal resource set.

In one embodiment, one first-type reference signal resource in the first reference signal resource set is used to determine a spatial transmission parameter of the first signal, or one second-type reference signal resource in the second reference signal resource set is used to determine a spatial transmission parameter of the first signal.

In one embodiment, when the target signal comprises only one sub-signal that is associated with the first reference signal resource set, the first candidate power value is used to generate the second information set, and the first candidate power value is the first target power value.

In one embodiment, when the target signal comprises only one sub-signal that is associated with the second reference signal resource set, the first candidate power value is used to generate the second information set, and the first candidate power value is the second target power value.

In one embodiment, when the target signal comprises two sub-signals that are respectively associated with the first reference signal resource set and the second reference signal resource set and are overlapping in time-frequency domain, the second candidate power value is used to generate the second information set, and the second candidate power value is equal to the sum of the third target power value and the fourth target power value.

In one embodiment, the step S30 is located after the step S10 and before the step S11 in Embodiment 5.

In one embodiment, the step S40 is located after the step S20 and before the step S21 in Embodiment 5.

### Embodiment 7

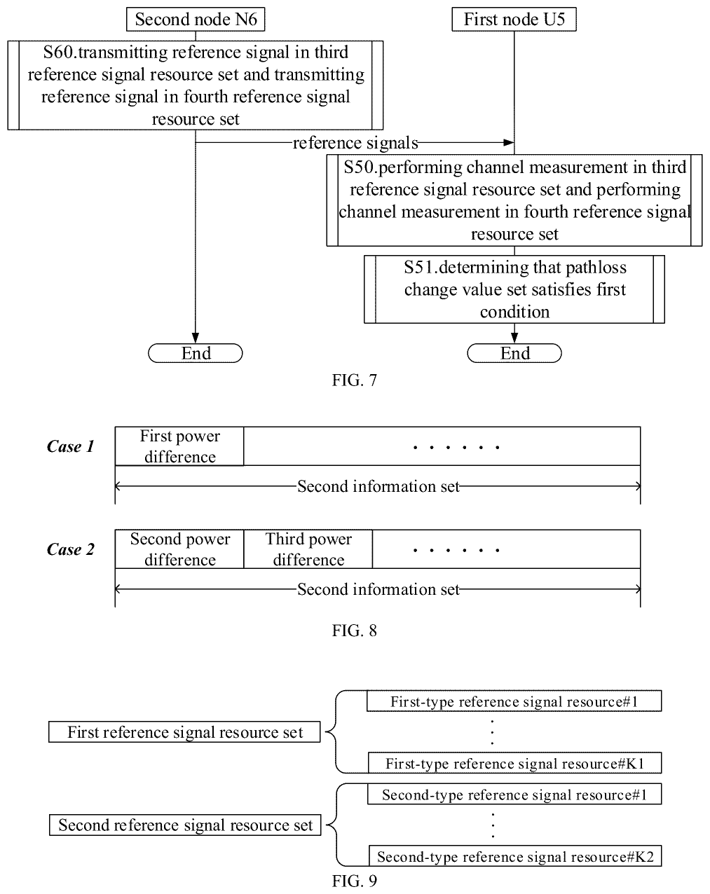

Embodiment 7 illustrates a flowchart of channel measurement, as shown in FIG. 7. In FIG. 7, a first node US and a second node N6 are in communication via a radio link. It should be particularly noted that the sequence illustrated herein does not set any limit to the signal transmission order or implementation order in the present application. In case of no conflict, the embodiments, sub-embodiments, and subsidiary embodiments in Embodiment 7 can be applied to any of Embodiments 5 or 6; conversely, in case of no conflict, the embodiments, sub-embodiments, and subsidiary embodiments in any of Embodiments 5 or 6 can be applied to Embodiment 7.

The first node US performs a channel measurement in a third reference signal resource set and performs a channel measurement in a fourth reference signal resource set in step S50; and determines that a pathloss change value set satisfies a first condition in step S51.

The second node N6 transmits a reference signal in a third reference signal resource set and transmits a reference signal in a fourth reference signal resource set in step S60.

In Embodiment 7, the third reference signal resource set is associated with the first reference signal resource set, and the fourth reference signal resource set is associated with the second reference signal resource set; whether the target signal comprises two sub-signals that are respectively associated with the first reference signal resource set and the second reference signal resource set and are overlapping in time-frequency domain is used to determine whether the channel measurement performed in the third reference signal resource set and the channel measurement performed in the fourth reference signal resource set are both used for generating the pathloss change value set.

In one embodiment, the step S50 includes receiving reference signal(s) in the third reference signal resource set, and receiving reference signal(s) in the fourth reference signal resource set.

In one subembodiment, the meaning of receiving reference signal(s) in the third reference signal resource set includes: receiving one or more reference signals in one or more of the K3 third-type reference signal resources included in the third reference signal resource set.

In one subembodiment, the meaning of receiving reference signal(s) in the fourth reference signal resource set includes: receiving one or more reference signals in one or more of the K4 fourth-type reference signal resources included in the fourth reference signal resource set.

In one embodiment, the third reference signal resource set comprises K3 third-type reference signal resource(s), K3 being a positive integer.

In one subembodiment, K3 is equal to 1.

In one subembodiment, K3 is greater than 1.

In one subembodiment, K3 is equal to K1, the K3 third-type reference signal resource(s) respectively corresponding to the K1 first-type reference signal resource(s).

In one subsidiary embodiment of the above subembodiment, a given third-type reference signal resource is any of the K3 third-type reference signal resource(s), the given third-type reference signal resource corresponds to a given first-type reference signal resource of the K1 first-type reference signal resource(s), and a radio signal transmitted in the given third-type reference signal resource is QCL with a radio signal transmitted in the given first-type reference signal resource.

In one subembodiment, there exists at least one third-type reference signal resource of the K3 third-type reference signal resource(s) in which a radio signal transmitted is QCL with a radio signal transmitted in one first-type reference signal resource of the K1 first-type reference signal resource(s).

In one subembodiment, any one of the K3 third-type reference signal resource(s) included in the third reference signal resource set is a CSI-RS Resource.

In one subembodiment, any one of the K3 third-type reference signal resource(s) included in the third reference signal resource set is an SSB.

In one embodiment, a radio signal transmitted in the third reference signal resource set and a radio signal transmitted in the first reference signal resource set are QCL.

In one embodiment, the fourth reference signal resource set comprises K4 fourth-type reference signal resource(s), K4 being a positive integer.

In one subembodiment, K4 is equal to 1.

In one subembodiment, K4 is greater than 1.

In one subembodiment, K4 is equal to K2, the K4 fourth-type reference signal resource(s) respectively corresponding to the K2 second-type reference signal resource(s).

In one subsidiary embodiment of the above subembodiment, a given fourth-type reference signal resource is any of the K4 fourth-type reference signal resource(s), the given fourth-type reference signal resource corresponds to a given second-type reference signal resource of the K2 second-type reference signal resource(s), and a radio signal transmitted in the given fourth-type reference signal resource is QCL with a radio signal transmitted in the given second-type reference signal resource.

In one subembodiment, there exists at least one fourth-type reference signal resource of the K4 fourth-type reference signal resource(s) in which a radio signal transmitted is QCL with a radio signal transmitted in one second-type reference signal resource of the K2 second-type reference signal resource(s).

In one subembodiment, any one of the K4 fourth-type reference signal resource(s) included in the fourth reference signal resource set is a CSI-RS Resource.

In one subembodiment, any one of the K4 fourth-type reference signal resource(s) included in the fourth reference signal resource set is an SSB.

In one embodiment, a radio signal transmitted in the fourth reference signal resource set and a radio signal transmitted in the second reference signal resource set are QCL.

Typically, when the target signal comprises only one sub-signal being associated with the first reference signal resource set, the pathloss change value set includes a first pathloss change value, and the channel measurement performed in the third reference signal resource set is used to determine the first pathloss change value, that the pathloss change value set satisfies the first condition includes that the first pathloss change value is greater than a first threshold; when the target signal comprises only one sub-signal being associated with the second reference signal resource set, the pathloss change value set includes a second pathloss change value, and the channel measurement performed in the fourth reference signal resource set is used to determine the second pathloss change value, that the pathloss change value set satisfies the first condition includes that the second pathloss change value is greater than a second threshold; when the target signal comprises two sub-signals that are respectively associated with the first reference signal resource set and the second reference signal resource set and are overlapping in time-frequency domain, the pathloss change value set includes a third pathloss change value and a fourth pathloss change value, the channel measurement performed in the third reference signal resource set is used to determine the third pathloss change value, and the channel measurement performed in the fourth reference signal resource set is used to determine the fourth pathloss change value, that the pathloss change value set satisfies the first condition includes that the third pathloss change value is greater than a third threshold and the fourth pathloss change value is greater than a fourth threshold.

In one embodiment, the phrase that the channel measurement performed in the third reference signal resource set is used to determine the first pathloss change value includes: measuring in each of the K3 third-type reference signal resources included in the third reference signal resource set to obtain K3 pathloss change values, the first pathloss change value being a greatest one of the K3 pathloss change values.

In one embodiment, the phrase that the channel measurement performed in the third reference signal resource set is used to determine the first pathloss change value includes: measuring in each of the K3 third-type reference signal resources included in the third reference signal resource set to obtain K3 pathloss change values, the first pathloss change value being a smallest one of the K3 pathloss change values.

In one embodiment, the phrase that the channel measurement performed in the third reference signal resource set is used to determine the first pathloss change value includes: measuring in each of the K3 third-type reference signal resources included in the third reference signal resource set to obtain K3 pathloss change values, the first pathloss change value being equal to an average of the K3 pathloss change values.

In one embodiment, the phrase that the channel measurement performed in the fourth reference signal resource set is used to determine the second pathloss change value includes: measuring in each of the K4 fourth-type reference signal resources included in the fourth reference signal resource set to obtain K4 pathloss change values, the second pathloss change value being a greatest one of the K4 pathloss change values.

In one embodiment, the phrase that the channel measurement performed in the fourth reference signal resource set is used to determine the second pathloss change value includes: measuring in each of the K4 fourth-type reference signal resources included in the fourth reference signal resource set to obtain K4 pathloss change values, the second pathloss change value being a smallest one of the K4 pathloss change values.

In one embodiment, the phrase that the channel measurement performed in the fourth reference signal resource set is used to determine the second pathloss change value includes: measuring in each of the K4 fourth-type reference signal resources included in the fourth reference signal resource set to obtain K4 pathloss change values, the second pathloss change value being equal to an average of the K4 pathloss change values.

In one embodiment, the phrase that the channel measurement performed in the third reference signal resource set is used to determine the third pathloss change value, and the channel measurement performed in the fourth reference signal resource set is used to determine the fourth pathloss change value includes: measuring in each of the K3 third-type reference signal resources included in the third reference signal resource set to obtain K3 pathloss change values, the third pathloss change value being a smallest one of the K3 pathloss change values; and measuring in each of the K4 fourth-type reference signal resources included in the fourth reference signal resource set to obtain K4 pathloss change values, the fourth pathloss change value being a smallest one of the K4 pathloss change values.

In one embodiment, the phrase that the channel measurement performed in the third reference signal resource set is used to determine the third pathloss change value, and the channel measurement performed in the fourth reference signal resource set is used to determine the fourth pathloss change value includes: measuring in each of the K3 third-type reference signal resources included in the third reference signal resource set to obtain K3 pathloss change values, the third pathloss change value being a greatest one of the K3 pathloss change values; and measuring in each of the K4 fourth-type reference signal resources included in the fourth reference signal resource set to obtain K4 pathloss change values, the fourth pathloss change value being a greatest one of the K4 pathloss change values.

In one embodiment, the phrase that the channel measurement performed in the third reference signal resource set is used to determine the third pathloss change value, and the channel measurement performed in the fourth reference signal resource set is used to determine the fourth pathloss change value includes: measuring in each of the K3 third-type reference signal resources included in the third reference signal resource set to obtain K3 pathloss change values, the third pathloss change value being equal to an average of the K3 pathloss change values; and measuring in each of the K4 fourth-type reference signal resources included in the fourth reference signal resource set to obtain K4 pathloss change values, the fourth pathloss change value being equal to an average of the K4 pathloss change values.

Typically, the first reference signal resource set comprises a first reference signal resource, and the second reference signal resource set comprises a second reference signal resource; a reference signal transmitted in the first reference signal resource is QCL with a reference signal transmitted in a third reference signal resource in the third reference signal resource set, while a reference signal transmitted in the second reference signal resource is QCL with a reference signal transmitted in a fourth reference signal resource in the fourth reference signal resource set; a channel measurement for the third reference signal resource or a channel measurement for the fourth reference signal resource is used to determine the first power difference; a channel measurement for the third reference signal resource is used to determine the second power difference, while a channel measurement for the fourth reference signal resource is used to determine the third power difference.

In one embodiment, the QCL refers to being Quasi Co-Located.

In one embodiment, the QCL refers to Quasi Co-Location.

In one embodiment, the QCL comprises a QCL parameter.

In one embodiment, the QCL comprises a QCL assumption.

In one embodiment, the QCL type includes QCL-Type A.

In one embodiment, the QCL type includes QCL-Type B.

In one embodiment, the QCL type includes QCL-Type C.

In one embodiment, the QCL type includes QCL-Type D.

In one embodiment, the QCL-TypeA comprises Doppler shift, Doppler spread, average delay and delay spread.

In one embodiment, the QCL-TypeB comprises Doppler shift and Doppler spread.

In one embodiment, the QCL-TypeC comprises Doppler shift and average delay.

In one embodiment, the QCL-TypeD comprises Spatial Rx parameter.

In one embodiment, the QCL parameters include at least one of a delay spread, a Doppler spread, a Doppler shift, an average delay, a Spatial Tx parameter or a Spatial Rx parameter.

In one embodiment, the Spatial Tx parameters include at least one of a transmission antenna port, a transmission antenna port group, a transmission analog beamforming matrix, a transmission analog beamforming vector, a transmission beamforming matrix, a transmission beamforming vector or a spatial domain transmission filter.

In one embodiment, a channel measurement for the third reference signal resource is used to determine the first power difference.

In one subembodiment, a pathloss determined based on a reference signal transmitted in the third reference signal resource is used to determine the first power difference.

In one embodiment, a channel measurement for the fourth reference signal resource is used to determine the first power difference.

In one subembodiment, a pathloss determined based on a reference signal transmitted in the fourth reference signal resource is used to determine the first power difference.

In one embodiment, a channel measurement for the third reference signal resource is used to determine the second power difference, and a channel measurement for the fourth reference signal resource is used to determine the third power difference.

In one subembodiment, a pathloss determined based on a reference signal transmitted in the third reference signal resource is used to determine the second power difference; a pathloss determined based on a reference signal transmitted in the fourth reference signal resource is used to determine the third power difference.

In one embodiment, the step S50 is located after the step S10 and before the step S11 in Embodiment 5.

In one embodiment, the step S60 is located after the step S20 and before the step S21 in Embodiment 5.

In one embodiment, the step S51 is located before the step S11 in Embodiment 5.

In one embodiment, the step S50 is located before the step S30 in Embodiment 6.

In one embodiment, the step S60 is located before the step S40 in Embodiment 6.

In one embodiment, the step S50 is located after the step S30 in Embodiment 6.

In one embodiment, the step S60 is located after the step S40 in Embodiment 6.

### Embodiment 8

Embodiment 8 illustrates a schematic diagram of a second information set, as shown in FIG. 8. In FIG. 8, in case 1, the second information set comprises a first power difference; in case 2, the second information set comprises a second power difference and a third power difference.

In one embodiment, a number of information bits occupied by the second information set is variable.

In one embodiment, a number of information bits occupied by the second information set is related to the target signal.

In one embodiment, the case 1 corresponds to that the target signal does not comprise two sub-signals that are respectively associated with the first reference signal resource set and the second reference signal resource set and are overlapping in time-frequency domain.

In one embodiment, the case 2 corresponds to that the target signal comprises two sub-signals that are respectively associated with the first reference signal resource set and the second reference signal resource set and are overlapping in time-frequency domain.

In one embodiment, the second information set comprises the first power value of this application.

In one embodiment, the second information set comprises a first field, the first field being used to indicate a ServCellIndex of a serving cell to which a given power difference corresponds, the given power difference being any one of the first power difference, the second power difference or the third power difference; the second power difference and the third power difference correspond to a same serving cell.

In one embodiment, the second information set comprises a second field, the second field being used to indicate whether a given power difference is based on an actual transmission or a Reference Format, the given power difference being any one of the first power difference, the second power difference, or the third power difference.

In one embodiment, the second information set comprises a third field, the third field being used to indicate whether a reference signal resource set associated with a given power difference is the first reference signal resource set or the second reference signal resource set, the given power difference being any one of the first power difference, the second power difference, or the third power difference.

In one embodiment, the second information set comprises a fourth field, the fourth field being used to indicate whether a given power difference is based on the use of one of the first reference signal resource set or the second reference signal resource set, or is based on the use of both the first reference signal resource set and the second reference signal resource set, the given power difference being any one of the first power difference, the second power difference, or the third power difference.

In one embodiment, corresponding to the ServCellIndex of a given serving cell, relative positions of the second power difference and the third power difference are fixed.

### Embodiment 9

Embodiment 9 illustrates a schematic diagram of a first reference signal resource set and a second reference signal resource set, as shown in FIG. 9. In FIG. 9, the first reference signal resource set comprises K1 first-type reference signal resource(s) corresponding to first-type reference signal resource #1 to first-type reference signal resource #K1 in the figure, respectively; the second reference signal resource set comprises K2 second-type reference signal resource(s) corresponding to second-type reference signal resource #1 to second-type reference signal resource #K2 in the figure, respectively; K1 is a positive integer and K2 is a positive integer.

In one embodiment, K1 is equal to 1, and the first reference signal resource set includes only the first reference signal resource in the present application.

In one embodiment, K2 is equal to 1, and the second reference signal resource set includes only the second reference signal resource in the present application.

In one embodiment, K1 is greater than 1.

In one embodiment, K2 is greater than 1.

In one embodiment, the first power value applies to all reference signal resources in the first reference signal resource set.

In one embodiment, the first power value applies to a first reference signal resource in the first reference signal resource set.

In one embodiment, the second power value applies to all reference signal resources in the second reference signal resource set.

In one embodiment, the second power value applies to a second reference signal resource in the second reference signal resource set.

In one embodiment, the third power value applies to all reference signal resources in the first reference signal resource set.

In one embodiment, the third power value applies to a first reference signal resource in the first reference signal resource set.

In one embodiment, the fourth power value applies to all reference signal resources in the second reference signal resource set.

In one embodiment, the fourth power value applies to a second reference signal resource in the second reference signal resource set.

In one embodiment, the first power value is used when the second information set includes only the first power difference.

In one embodiment, the second power value is used when the second information set includes only the first power difference.

In one embodiment, the third power value is used when the second information set includes both the second power difference and the third power difference.

In one embodiment, the fourth power value is used when the second information set includes both the second power difference and the third power difference.

In one embodiment, the first reference signal resource set and the second reference signal resource set respectively correspond to two different Panel IDs.

In one embodiment, the first reference signal resource set and the second reference signal resource set respectively correspond to two Panels included in the first node.

In one embodiment, the first reference signal resource set and the second reference signal resource set respectively correspond to two Radio Frequencies (RFs) included in the first node.

In one embodiment, the first reference signal resource set and the second reference signal resource set respectively correspond to two RF channels included in the first node.

### Embodiment 10

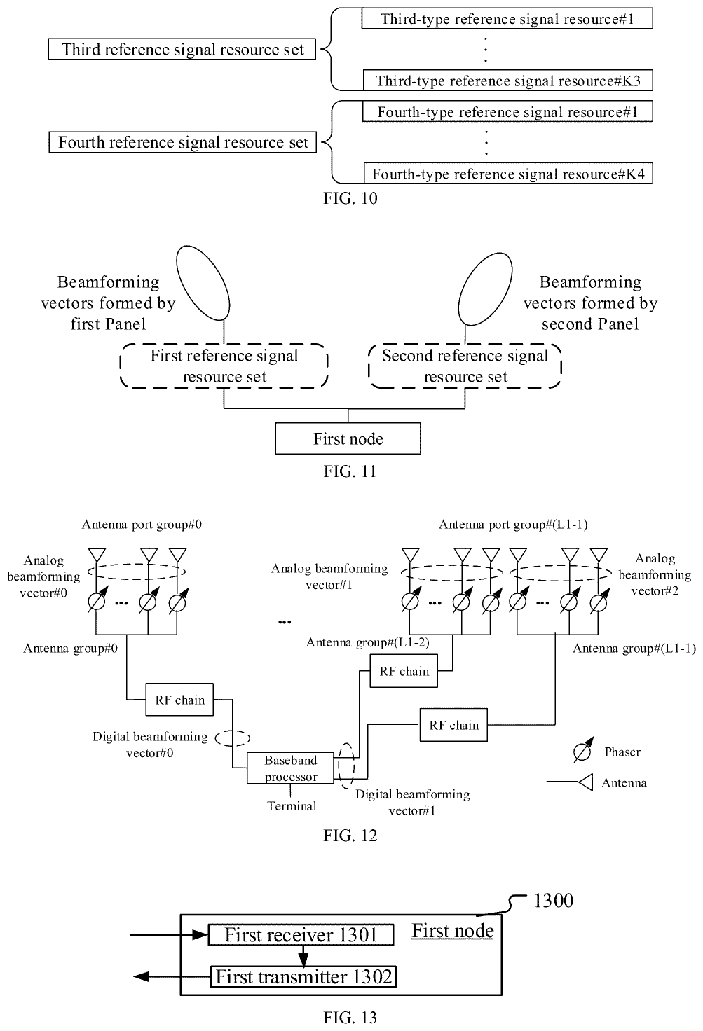

Embodiment 10 illustrates a schematic diagram of a third reference signal resource set and a fourth reference signal resource set, as shown in FIG. 10. In FIG. 10 of the accompanying drawings, the third reference signal resource set comprises K3 third-type reference signal resource(s) corresponding to third-type reference signal resource #1 to third-type reference signal resource #K3 in the figure, respectively; the fourth reference signal resource set comprises K4 fourth-type reference signal resource(s) corresponding to fourth-type reference signal resource #1 to fourth-type reference signal resource #K4 in the figure, respectively; K3 is a positive integer and K4 is a positive integer.

In one embodiment, K3 is equal to 1, and the third reference signal resource set includes only the third reference signal resource in the present application.

In one embodiment, K4 is equal to 1, and the fourth reference signal resource set includes only the fourth reference signal resource in the present application.

In one embodiment, K3 is greater than 1.

In one embodiment, K4 is greater than 1.

In one embodiment, the first power value applies to all reference signal resources in the third reference signal resource set.

In one embodiment, the first power value applies to a third reference signal resource in the third reference signal resource set.

In one embodiment, the second power value applies to all reference signal resources in the fourth reference signal resource set.

In one embodiment, the second power value applies to a fourth reference signal resources in the fourth reference signal resource set.

In one embodiment, the third power value applies to all reference signal resources in the third reference signal resource set.

In one embodiment, the third power value applies to a third reference signal resource in the third reference signal resource set.

In one embodiment, the fourth power value applies to all reference signal resources in the fourth reference signal resource set.

In one embodiment, the fourth power value applies to a fourth reference signal resources in the fourth reference signal resource set.

In one embodiment, the third reference signal resource set and the fourth reference signal resource set respectively correspond to two different IDs.

In one embodiment, the third reference signal resource set and the fourth reference signal resource set respectively correspond to two different PCIs.

In one embodiment, the third reference signal resource set and the fourth reference signal resource set respectively correspond to two TRPs included in the second node.

In one embodiment, the third reference signal resource set and the fourth reference signal resource set respectively correspond to two RF channels included in the second node.

### Embodiment 11

Embodiment 11 illustrates a schematic of a first node, as shown in FIG. 11. In FIG. 11, the first node has two Panels, i.e., a first Panel and a second Panel, the first Panel and the second Panel being associated with a first reference signal resource set and a second reference signal resource set, respectively; and the two Panels are capable of transmitting two independent radio signals in the same block of time-frequency resource.

In one embodiment, the first Panel and the second Panel can dynamically share a maximum transmission power value between each other.

In one embodiment, when the first Panel or the second Panel is used individually, a maximum transmission power value of the first Panel or the second Panel is no greater than a first threshold.

In one embodiment, the first power value in this application is no greater than the first threshold.

In one embodiment, the second power value in this application is no greater than the first threshold.

In one embodiment, when the first Panel and the second Panel are used together, a maximum transmission power value of the first Panel and a maximum transmission power value of the second Panel are not greater than a second threshold and a third threshold, respectively.

In one embodiment, the third power value in this application is no greater than the second threshold.

In one embodiment, the fourth power value in this application is no greater than the third threshold.

### Embodiment 12

Embodiment 12 illustrates a schematic diagram of antennas and antenna port groups, as shown in FIG. 12.

In Embodiment 12, an antenna port group consists of a positive integer number of antenna port(s); an antenna port is formed by superimposing antennas in a positive integer number of antenna group(s) through Antenna Virtualization. One antenna group is connected to a baseband processor through a Radio Frequency (RF) chain, so each antenna group corresponds to a different RF chain. Mapping coefficients of all antennas in a positive integer number of antenna group(s) comprised by a given antenna port to the given antenna port constitute a beamforming vector corresponding to the given antenna port. Mapping coefficients of multiple antennas comprised in any given one of a positive integer number of antenna groups comprised by the given antenna port to the given antenna port constitute an analog beamforming vector for the given antenna port. Analog beamforming vectors respectively corresponding to the positive integer number of antenna groups are diagonally arranged to form an analog beamforming matrix corresponding to the given antenna port. Mapping coefficients of the positive integer number of antenna groups to the given antenna port constitute a digital beamforming vector corresponding to the given antenna port. A beamforming vector corresponding to the given antenna port is a product of the analog beamforming matrix and the digital beamforming vector respectively corresponding to the given antenna port. Each antenna port in antenna port group is composed of (a) same antenna group(s), and different antenna ports in a same antenna port group correspond to different beamforming vectors.

FIG. 12 illustrates two antenna port groups, which are antenna port group #0 and antenna port group #1. Herein, the antenna port group is composed of antenna group #0, while the antenna port group #1 is composed of antenna group #1 and antenna group #2. Mapping coefficients of multiple antennas comprised in the antenna group #0 to the antenna port group #0 constitute an analog beamforming vector #0; a mapping coefficient of the antenna group #0 to the antenna port group #0 constitute a digital beamforming vector #0. Mapping coefficients of multiple antennas comprised in the antenna group #1 to the antenna port group #1 and mapping coefficients of multiple antennas comprised in the antenna group #2 to the antenna port group #1 respectively constitute an analog beamforming vector #1 and an analog beamforming vector #2; respective mapping coefficients of the antenna group #1 and the antenna group #2 to the antenna port group #1 constitute a digital beamforming vector #1. A beamforming vector corresponding to any antenna port comprised by the antenna port group #0 is a product of the analog beamforming vector #0 and the digital beamforming vector #0. A beamforming vector corresponding to any antenna port comprised by the antenna port group #1 is a product of the digital beamforming vector #1 and an analog beamforming matrix formed by diagonally arrangement of the analog beamforming vector #1 and the analog beamforming vector #2.

In one subembodiment, an antenna port group comprises one antenna port. For example, the antenna port group #0 in FIG. 12 comprises one antenna port.

In one subsidiary embodiment of the above subembodiment, an analog beamforming matrix corresponding to the one antenna port is dimensionally reduced to an analog beamforming vector, while a digital beamforming vector corresponding to the one antenna port is dimensionally reduced to a scaler, a beamforming vector corresponding to the one antenna port is equivalent to an analog beamforming vector corresponding to the one antenna port.

In one subembodiment, an antenna port group comprises multiple antenna ports. For example, the antenna port group #1 in FIG. 12 comprises multiple antenna ports.

In one subsidiary embodiment of the above subembodiment, the multiple antenna ports correspond to a same analog beamforming matrix and different digital beamforming vectors.

In one subembodiment, antenna ports in different antenna port groups correspond to different analog beamforming matrices.

In one subembodiment, any two antenna ports in an antenna port group are Quasi-Colocated (QCL).

In one subembodiment, any two antenna ports in an antenna port group are spatial QCL.

In one embodiment, the multiple antenna port groups in the figure correspond to a Panel in this application.

In one embodiment, the first reference signal resource set corresponds to multiple antenna port groups.

In one embodiment, the second reference signal resource set corresponds to multiple antenna port groups.

In one embodiment, one reference signal resource in the first reference signal resource set corresponds to one antenna port group.

In one embodiment, one reference signal resource in the second reference signal resource set corresponds to one antenna port group.

### Embodiment 13

Embodiment 13 illustrates a structure block diagram of a first node, as shown in FIG. 13. In FIG. 13, a first node 1300 comprises a first receiver 1301 and a first transmitter 1302.

The first receiver 1301 receives a first information set, the first information set indicating a first reference signal resource set and a second reference signal resource set;

the first transmitter 1302 transmits a target signal, the target signal comprising a second information set.

In Embodiment 13, the second information set comprises a first power difference, or the second information set comprises a second power difference and a third power difference; the first power difference is associated with either the first reference signal resource set or the second reference signal resource set; the second power difference is associated with the first reference signal resource set, and the third power difference is associated with the second reference signal resource set; whether the target signal comprises two sub-signals that are respectively associated with the first reference signal resource set and the second reference signal resource set and are overlapping in time-frequency domain is used to determine whether the second information set comprises the first power difference or comprises both the second power difference and the third power difference.

In one embodiment, when the target signal comprises two sub-signals that are respectively associated with the first reference signal resource set and the second reference signal resource set and are overlapping in time-frequency domain, the second information set comprises the second power difference and the third power difference.

In one embodiment, characterized in comprising:
the first transmitter 1302, transmitting a first signal in a first time window and transmitting a second signal in a second time window;
herein, the first signal and the second signal respectively correspond to different scheduling signalings, the first signal is associated with the first reference signal resource set, and the second signal comprises two sub-signals that are respectively associated with the first reference signal resource set and the second reference signal resource set and are overlapping in time-frequency domain; a transmission power value of the first signal is a first candidate power value, and a transmission power value of the second signal is a second candidate power value; whether the target signal comprises two sub-signals that are respectively associated with the first reference signal resource set and the second reference signal resource set and are overlapping in time-frequency domain is used to determine whether the first candidate power value or the second candidate power value is used for generating the second information set.

In one embodiment, the first power difference is equal to a difference obtained by subtracting a first reference power value from a first power value, or the first power difference is equal to a difference obtained by subtracting a second reference power value from a second power value; the second power difference is equal to a difference obtained by subtracting a third reference power value from a third power value, and the third power difference is equal to a difference obtained by subtracting a fourth reference power value from a fourth power value; the first reference power value is associated with the first reference signal resource set, the second reference power value is associated with the second reference signal resource set, the third reference power value is associated with the first reference signal resource set, and the fourth reference power value is associated with the second reference signal resource set; the first reference power value or the second reference power value is a transmission power value of a first reference PUSCH, while the third reference power value and the fourth reference power value are respectively related to a transmission power value of a second reference PUSCH; the first reference PUSCH is different from the second reference PUSCH.

In one embodiment, characterized in comprising:
the first receiver 1301, performing a channel measurement in a third reference signal resource set and performing a channel measurement in a fourth reference signal resource set; and determining that a pathloss change value set satisfies a first condition;
herein, the third reference signal resource set is associated with the first reference signal resource set, and the fourth reference signal resource set is associated with the second reference signal resource set; whether the target signal comprises two sub-signals that are respectively associated with the first reference signal resource set and the second reference signal resource set and are overlapping in time-frequency domain is used to determine whether the channel measurement performed in the third reference signal resource set and the channel measurement performed in the fourth reference signal resource set are both used for generating the pathloss change value set.

In one embodiment, when the target signal comprises only one sub-signal being associated with the first reference signal resource set, the pathloss change value set includes a first pathloss change value, and the channel measurement performed in the third reference signal resource set is used to determine the first pathloss change value, that the pathloss change value set satisfies the first condition includes that the first pathloss change value is greater than a first threshold; when the target signal comprises only one sub-signal being associated with the second reference signal resource set, the pathloss change value set includes a second pathloss change value, and the channel measurement performed in the fourth reference signal resource set is used to determine the second pathloss change value, that the pathloss change value set satisfies the first condition includes that the second pathloss change value is greater than a second threshold; when the target signal comprises two sub-signals that are respectively associated with the first reference signal resource set and the second reference signal resource set and are overlapping in time-frequency domain, the pathloss change value set includes a third pathloss change value and a fourth pathloss change value, the channel measurement performed in the third reference signal resource set is used to determine the third pathloss change value, and the channel measurement performed in the fourth reference signal resource set is used to determine the fourth pathloss change value, that the pathloss change value set satisfies the first condition includes that the third pathloss change value is greater than a third threshold and the fourth pathloss change value is greater than a fourth threshold.

In one embodiment, the first reference signal resource set comprises a first reference signal resource, and the second reference signal resource set comprises a second reference signal resource; a reference signal transmitted in the first reference signal resource is QCL with a reference signal transmitted in a third reference signal resource in the third reference signal resource set, while a reference signal transmitted in the second reference signal resource is QCL with a reference signal transmitted in a fourth reference signal resource in the fourth reference signal resource set; a channel measurement for the third reference signal resource or a channel measurement for the fourth reference signal resource is used to determine the first power difference; a channel measurement for the third reference signal resource is used to determine the second power difference, while a channel measurement for the fourth reference signal resource is used to determine the third power difference.

In one embodiment, the first receiver 1301 comprises at least the first four of the antenna 452, the receiver 454, the multi-antenna receiving processor 458, the receiving processor 456 and the controller/processor 459 in Embodiment 4.

In one embodiment, the first transmitter 1302 comprises at least the first four of the antenna 452, the transmitter 454, the multi-antenna transmitting processor 457, the transmitting processor 468 and the controller/processor 459 in Embodiment 4.

In one embodiment, the first information set is transmitted via RRC signaling; the first reference signal resource set and the second reference signal resource set are two different SRS Resource Sets, respectively; the second information set is a PHR, the first power difference is a PH; the second power difference and the third power difference are both PHs; the target signal is a PUSCH, when the target signal comprises only one sub-signal that is associated with either the first reference signal resource set or the second reference signal resource set, the second information set comprises only the first power difference; when the target signal comprises two sub-signals that are respectively associated with the first reference signal resource set and the second reference signal resource set and are overlapping in time-frequency domain, the second information set comprises both the second power difference and the third power difference.

### Embodiment 14

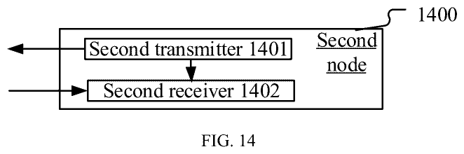

Embodiment 14 illustrates a structure block diagram of a second node, as shown in FIG. 14. In FIG. 14, a second node 1400 comprises a second transmitter 1401 and a second receiver 1402.

The second transmitter 1401 transmits a first information set, the first information set indicating a first reference signal resource set and a second reference signal resource set;
the second receiver 1402 receives a target signal, the target signal comprising a second information set.

In Embodiment 14, the second information set comprises a first power difference, or the second information set comprises a second power difference and a third power difference; the first power difference is associated with either the first reference signal resource set or the second reference signal resource set; the second power difference is associated with the first reference signal resource set, and the third power difference is associated with the second reference signal resource set; whether the target signal comprises two sub-signals that are respectively associated with the first reference signal resource set and the second reference signal resource set and are overlapping in time-frequency domain is used to determine whether the second information set comprises the first power difference or comprises both the second power difference and the third power difference.

In one embodiment, when the target signal comprises two sub-signals that are respectively associated with the first reference signal resource set and the second reference signal resource set and are overlapping in time-frequency domain, the second information set comprises the second power difference and the third power difference.

In one embodiment, comprising:
the second receiver 1402, receiving a first signal in a first time window and receiving a second signal in a second time window;
herein, the first signal and the second signal respectively correspond to different scheduling signalings, the first signal is associated with the first reference signal resource set, and the second signal comprises two sub-signals that are respectively associated with the first reference signal resource set and the second reference signal resource set and are overlapping in time-frequency domain; a transmission power value of the first signal is a first candidate power value, and a transmission power value of the second signal is a second candidate power value; whether the target signal comprises two sub-signals that are respectively associated with the first reference signal resource set and the second reference signal resource set and are overlapping in time-frequency domain is used to determine whether the first candidate power value or the second candidate power value is used for generating the second information set.

In one embodiment, the first power difference is equal to a difference obtained by subtracting a first reference power value from a first power value, or the first power difference is equal to a difference obtained by subtracting a second reference power value from a second power value; the second power difference is equal to a difference obtained by subtracting a third reference power value from a third power value, and the third power difference is equal to a difference obtained by subtracting a fourth reference power value from a fourth power value; the first reference power value is associated with the first reference signal resource set, the second reference power value is associated with the second reference signal resource set, the third reference power value is associated with the first reference signal resource set, and the fourth reference power value is associated with the second reference signal resource set; the first reference power value or the second reference power value is a transmission power value of a first reference PUSCH, while the third reference power value and the fourth reference power value are respectively related to a transmission power value of a second reference PUSCH; the first reference PUSCH is different from the second reference PUSCH.

In one embodiment, comprising:
the second transmitter 1401, transmitting a reference signal in a third reference signal resource set and transmitting a reference signal in a fourth reference signal resource set;
herein, the third reference signal resource set is associated with the first reference signal resource set, and the fourth reference signal resource set is associated with the second reference signal resource set; a transmitter of the target signal is a first node; whether the target signal comprises two sub-signals that are respectively associated with the first reference signal resource set and the second reference signal resource set and are overlapping in time-frequency domain is used by the first node to determine whether the channel measurement performed in the third reference signal resource set and the channel measurement performed in the fourth reference signal resource set are both used for generating a pathloss change value set; the pathloss change value set satisfies a first condition.

In one embodiment, when the target signal comprises only one sub-signal being associated with the first reference signal resource set, the pathloss change value set includes a first pathloss change value, and the channel measurement performed in the third reference signal resource set is used to determine the first pathloss change value, that the pathloss change value set satisfies the first condition includes that the first pathloss change value is greater than a first threshold; when the target signal comprises only one sub-signal being associated with the second reference signal resource set, the pathloss change value set includes a second pathloss change value, and the channel measurement performed in the fourth reference signal resource set is used to determine the second pathloss change value, that the pathloss change value set satisfies the first condition includes that the second pathloss change value is greater than a second threshold; when the target signal comprises two sub-signals that are respectively associated with the first reference signal resource set and the second reference signal resource set and are overlapping in time-frequency domain, the pathloss change value set includes a third pathloss change value and a fourth pathloss change value, the channel measurement performed in the third reference signal resource set is used to determine the third pathloss change value, and the channel measurement performed in the fourth reference signal resource set is used to determine the fourth pathloss change value, that the pathloss change value set satisfies the first condition includes that the third pathloss change value is greater than a third threshold and the fourth pathloss change value is greater than a fourth threshold.

In one embodiment, the first reference signal resource set comprises a first reference signal resource, and the second reference signal resource set comprises a second reference signal resource; a reference signal transmitted in the first reference signal resource is QCL with a reference signal transmitted in a third reference signal resource in the third reference signal resource set, while a reference signal transmitted in the second reference signal resource is QCL with a reference signal transmitted in a fourth reference signal resource in the fourth reference signal resource set; a channel measurement for the third reference signal resource or a channel measurement for the fourth reference signal resource is used to determine the first power difference; a channel measurement for the third reference signal resource is used to determine the second power difference, while a channel measurement for the fourth reference signal resource is used to determine the third power difference.

In one embodiment, the second transmitter 1401 comprises at least the first four of the antenna 420, the transmitter 418, the multi-antenna transmitting processor 471, the transmitting processor 414 and the controller/processor 475 in Embodiment 4.

In one embodiment, the second receiver 1402 comprises at least the first four of the antenna 420, the receiver 418, the multi-antenna receiving processor 472, the receiving processor 470 and the controller/processor 475 in Embodiment 4.

In one embodiment, the first information set is transmitted via RRC signaling; the first reference signal resource set and the second reference signal resource set are two different SRS Resource Sets, respectively; the second information set is a PHR, the first power difference is a PH; the second power difference and the third power difference are both PHs; the target signal is a PUSCH, when the target signal comprises only one sub-signal that is associated with either the first reference signal resource set or the second reference signal resource set, the second information set comprises only the first power difference; when the target signal comprises two sub-signals that are respectively associated with the first reference signal resource set and the second reference signal resource set and are overlapping in time-frequency domain, the second information set comprises both the second power difference and the third power difference.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The first node in the present application includes but is not limited to mobile phones, tablet computers, notebooks, network cards, low-consumption equipment, enhanced MTC (eMTC) terminals, NB-IoT terminals, vehicle-mounted communication equipment, vehicles, automobiles, RSU, aircrafts, airplanes, unmanned aerial vehicles, telecontrolled aircrafts, etc. The second node in the present application includes but is not limited to macro-cellular base stations, micro-cellular base stations, home base stations, relay base station, eNB, gNB, Transmitter Receiver Point (TRP), GNSS, relay satellite, satellite base station, airborne base station, RSU, unmanned ariel vehicle, test equipment like transceiving device simulating partial functions of base station or signaling tester, and other radio communication equipment.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first information set, the first information set indicating a first reference signal resource set and a second reference signal resource set; and
a first transmitter, transmitting a target signal, the target signal comprising a second information set:
wherein the second information set comprises a first power difference, or the second information set comprises a second power difference and a third power difference: the first power difference is associated with either the first reference signal resource set or the second reference signal resource set: the second power difference is associated with the first reference signal resource set, and the third power difference is associated with the second reference signal resource set: whether the target signal comprises two sub-signals that are respectively associated with the first reference signal resource set and the second reference signal resource set and are overlapping in time-frequency domain is used to determine whether the second information set comprises the first power difference or comprises both the second power difference and the third power difference.

2. The first node according to claim 1, characterized in that when the target signal does not comprise two sub-signals that are respectively associated with the first reference signal resource set and the second reference signal resource set and are overlapping in time-frequency domain, the second information set comprises only the first power difference of the first power difference, the second power difference and the third power difference, and both the target signal and the first power difference are associated with the first reference signal resource set or the second reference signal resource set.

3. The first node according to claim 1, characterized in that when the target signal comprises two sub-signals that are respectively associated with the first reference signal resource set and the second reference signal resource set and are overlapping in time-frequency domain, the second information set comprises the second power difference and the third power difference.

4. The first node according to claim 1, characterized in comprising:
the first transmitter, transmitting a first signal in a first time window and transmitting a second signal in a second time window;
wherein the first signal and the second signal respectively correspond to different scheduling signalings, the first signal is associated with the first reference signal resource set, and the second signal comprises two sub-signals that are respectively associated with the first reference signal resource set and the second reference signal resource set and are overlapping in time-frequency domain: a transmission power value of the first signal is a first candidate power value, and a transmission power value of the second signal is a second candidate power value: whether the target signal comprises two sub-signals that are respectively associated with the first reference signal resource set and the second reference signal resource set and are overlapping in time-frequency domain is used to determine whether the first candidate power value or the second candidate power value is used for generating the second information set.

5. The first node according to claim 1, characterized in that the first power difference is equal to a difference obtained by subtracting a first reference power value from a first power value, or the first power difference is equal to a difference obtained by subtracting a second reference power value from a second power value: the second power difference is equal to a difference obtained by subtracting a third reference power value from a third power value, and the third power difference is equal to a difference obtained by subtracting a fourth reference power value from a fourth power value: the first reference power value is associated with the first reference signal resource set, the second reference power value is associated with the second reference signal resource set, the third reference power value is associated with the first reference signal resource set, and the fourth reference power value is associated with the second reference signal resource set: the first reference power value or the second reference power value is a transmission power value of a first reference PUSCH, while the third reference power value and the fourth reference power value are respectively related to a transmission power value of a second reference PUSCH: the first reference PUSCH is different from the second reference PUSCH.

6. The first node according to claim 1, characterized in comprising:
the first receiver, performing a channel measurement in a third reference signal resource set and performing a channel measurement in a fourth reference signal resource set; and determining that a pathloss change value set satisfies a first condition;
wherein the third reference signal resource set is associated with the first reference signal resource set, and the fourth reference signal resource set is associated with the second reference signal resource set: whether the target signal comprises two sub-signals that are respectively associated with the first reference signal resource set and the second reference signal resource set and are overlapping in time-frequency domain is used to determine whether the channel measurement performed in the third reference signal resource set and the channel measurement performed in the fourth reference signal resource set are both used for generating the pathloss change value set.

7. The first node according to claim 6, characterized in that when the target signal comprises only one sub-signal being associated with the first reference signal resource set, the pathloss change value set includes a first pathloss change value, and the channel measurement performed in the third reference signal resource set is used to determine the first pathloss change value, that the pathloss change value set satisfies the first condition includes that the first pathloss change value is greater than a first threshold: when the target signal comprises only one sub-signal being associated with the second reference signal resource set, the pathloss change value set includes a second pathloss change value, and the channel measurement performed in the fourth reference signal resource set is used to determine the second pathloss change value, that the pathloss change value set satisfies the first condition includes that the second pathloss change value is greater than a second threshold: when the target signal comprises two sub-signals that are respectively associated with the first reference signal resource set and the second reference signal resource set and are overlapping in time-frequency domain, the pathloss change value set includes a third pathloss change value and a fourth pathloss change value, the channel measurement performed in the third reference signal resource set is used to determine the third pathloss change value, and the channel measurement performed in the fourth reference signal resource set is used to determine the fourth pathloss change value, that the pathloss change value set satisfies the first condition includes that the third pathloss change value is greater than a third threshold and the fourth pathloss change value is greater than a fourth threshold.

8. The first node according to claim 6, characterized in that the first reference signal resource set comprises a first reference signal resource, and the second reference signal resource set comprises a second reference signal resource: a reference signal transmitted in the first reference signal resource is QCL with a reference signal transmitted in a third reference signal resource in the third reference signal resource set, while a reference signal transmitted in the second reference signal resource is QCL with a reference signal transmitted in a fourth reference signal resource in the fourth reference signal resource set: a channel measurement for the third reference signal resource or a channel measurement for the fourth reference signal resource is used to determine the first power difference: a channel measurement for the third reference signal resource is used to determine the second power difference, while a channel measurement for the fourth reference signal resource is used to determine the third power difference.

9. The first node according to claim 2, characterized in that the first power difference is associated with the first reference signal resource set, and the first power difference is a corresponding power headroom (PH) for the first node transmitting a radio signal generated by one Transport Block (TB) only on a spatial transmission parameter corresponding to one reference signal resource in the first reference signal resource set.

10. The first node according to claim 2, characterized in that the first power difference is equal to a difference obtained by subtracting a first target power value from a first power value, at least one of the first power value or the first target power value being associated with the first reference signal resource set: the first target power value is a power value for a radio signal that the first node transmits only on a spatial transmission parameter corresponding to one reference signal resource in the first reference signal resource set, or the first target power value is a power value for a radio signal that the first node assumes to transmit only on a spatial transmission parameter corresponding to one reference signal resource in the first reference signal resource set.

11. The first node according to claim 2, characterized in that the first power difference is associated with the second reference signal resource set, and the first power difference is a corresponding PH for the first node transmitting a radio signal generated by one TB only on a spatial transmission parameter corresponding to one reference signal resource in the second reference signal resource set.

12. The first node according to claim 2, characterized in that the first power difference is equal to a difference obtained by subtracting a second target power value from a second power value, at least one of the second power value or the second target power value being associated with the second reference signal resource set: the second target power value is a power value for a radio signal that the first node transmits only on a spatial transmission parameter corresponding to one reference signal resource in the second reference signal resource set, or the second target power value is a power value for a radio signal that the first node assumes to transmit only on a spatial transmission parameter corresponding to one reference signal resource in the second reference signal resource set.

13. The first node according to claim 3, characterized in that the second power difference is associated with the first reference signal resource set, and the third power difference is associated with the second reference signal resource set: the second power difference and the third power difference are two PHs respectively corresponding to the first node transmitting two radio signals generated by two TBs simultaneously on a spatial transmission parameter corresponding to one reference signal resource in the first reference signal resource set and a spatial transmission parameter corresponding to one reference signal resource in the second reference signal resource set.

14. The first node according to claim 3, characterized in that the second power difference is equal to a difference obtained by subtracting a third target power value from a third power value, and the third power difference is equal to a difference obtained by subtracting a fourth target power value from a fourth power value: at least one of the third power value or the third target power value is associated with the first reference signal resource set, and at least one of the fourth power value or the fourth target power value is associated with the second reference signal resource set.

15. The first node according to claim 14, characterized in that the third target power value and the fourth target power value are power values respectively used for the first node transmitting two radio sub-signals simultaneously on a spatial transmission parameter corresponding to one reference signal resource in the first reference signal resource set and on a spatial transmission parameter corresponding to one reference signal resource in the second reference signal resource set: or, the third target power value and the fourth target power value are power values respectively used for the first node assuming to be transmitting two radio sub-signals simultaneously on a spatial transmission parameter corresponding to one reference signal resource in the first reference signal resource set and on a spatial transmission parameter corresponding to one reference signal resource in the second reference signal resource set.

16. A second node for wireless communications, comprising:
a second transmitter, transmitting a first information set, the first information set indicating a first reference signal resource set and a second reference signal resource set; and
a second receiver, receiving a target signal, the target signal comprising a second information set;
wherein the second information set comprises a first power difference, or the second information set comprises a second power difference and a third power difference: the first power difference is associated with either the first reference signal resource set or the second reference signal resource set: the second power difference is associated with the first reference signal resource set, and the third power difference is associated with the second reference signal resource set: whether the target signal comprises two sub-signals that are respectively associated with the first reference signal resource set and the second reference signal resource set and are overlapping in time-frequency domain is used to determine whether the second information set comprises the first power difference or comprises both the second power difference and the third power difference.

17. The second node according to claim 16, characterized in that when the target signal does not comprise two sub-signals that are respectively associated with the first reference signal resource set and the second reference signal resource set and are overlapping in time-frequency domain, the second information set comprises only the first power difference of the first power difference, the second power difference and the third power difference, and both the target signal and the first power difference are associated with the first reference signal resource set or the second reference signal resource set.

18. The second node according to claim 16, characterized in that when the target signal comprises two sub-signals that are respectively associated with the first reference signal resource set and the second reference signal resource set and are overlapping in time-frequency domain, the second information set comprises the second power difference and the third power difference.

19. The second node according to claim 16, characterized in comprising:
the second receiver, receiving a first signal in a first time window and receiving a second signal in a second time window;
wherein the first signal and the second signal respectively correspond to different scheduling signalings, the first signal is associated with the first reference signal resource set, and the second signal comprises two sub-signals that are respectively associated with the first reference signal resource set and the second reference signal resource set and are overlapping in time-frequency domain: a transmission power value of the first signal is a first candidate power value, and a transmission power value of the second signal is a second candidate power value; whether the target signal comprises two sub-signals that are respectively associated with the first reference signal resource set and the second reference signal resource set and are overlapping in time-frequency domain is used to determine whether the first candidate power value or the second candidate power value is used for generating the second information set.

20. A method in a first node for wireless communications, comprising:
receiving a first information set, the first information set indicating a first reference signal resource set and a second reference signal resource set; and
transmitting a target signal, the target signal comprising a second information set;
wherein the second information set comprises a first power difference, or the second information set comprises a second power difference and a third power difference: the first power difference is associated with either the first reference signal resource set or the second reference signal resource set; the second power difference is associated with the first reference signal resource set, and the third power difference is associated with the second reference signal resource set; whether the target signal comprises two sub-signals that are respectively associated with the first reference signal resource set and the second reference signal resource set and are overlapping in time-frequency domain is used to determine whether the second information set comprises the first power difference or comprises both the second power difference and the third power difference.
